(19) United States
(12) Patent Application Publication
(10) Pub. No.: US 2016/0077047 A1
(43) Pub. Date: Mar. 17, 2016

(54) SENSORS FOR ANALYTE DETECTION

(71) Applicant: Adamant Technologies, Inc., South San Francisco, CA (US)

(72) Inventors: Samuel M. Khamis, South San Francisco, CA (US); Timothy V. Ratto, South San Francisco, CA (US); Aaron Dennison-Gibby, South San Francisco, CA (US); Gary Shambat, South San Francisco, CA (US); Nishant Neel, South San Francisco, CA (US); Elise Minkin, South San Francisco, CA (US); Jeremy Gofman, South San Francisco, CA (US)

(21) Appl. No.: 14/801,528

(22) Filed: Jul. 16, 2015

Related U.S. Application Data
(63) Continuation of application No. PCT/US2014/012129, filed on Jan. 17, 2014.
(60) Provisional application No. 61/754,369, filed on Jan. 18, 2013.
(60) Provisional application No. 61/907,971, filed on Nov. 22, 2013.

(51) Int. Cl. G01N 27/414

(52) U.S. Cl. CPC G01N 27/4141

(57) ABSTRACT

The disclosure provides devices and methods for chemical sensing that are capable of achieving compact, fast chemical sensing with high sensitivity and specificity. Devices of the disclosure generally comprise a plurality of sensors arranged in at least one array. Each sensor of a device may be addressable and capable of generating a response when in contact with a given chemical. Such a device may be used to execute sensing methods that may be useful in a range of applications.

### CROSS-REFERENCE

This application claims priority to U.S. Provisional Patent Application No. 61/754,369, filed Jan. 18, 2013, and U.S. Provisional Patent Application No. 61/907,971, filed Nov. 22, 2013, which are entirely incorporated herein by reference.

### BACKGROUND

An electronic nose is a device that may detect odors or flavors. Electronic sensing may refer to the capability of reproducing human senses using sensor arrays and pattern recognition systems. The stages of the recognition process may be similar to human olfaction and are performed for identification, comparison, quantification and other applications, including data storage and retrieval. An electronic nose may imitate the physiologic performance of the human nose, such as detecting chemicals that are at hazardous levels, and, in some cases may be undetectable by the human nose. An electronic nose may also detect volatile chemicals hidden in devices that may be used to execute an explosive, chemical, or biological attack. Other uses of electronic noses include monitoring a range of physiological states.

### SUMMARY

Recognized herein is the need for functional chemical vapor sensing devices and methods capable of compactly detecting volatile compounds at a range of detection sensitivities and in vapor mixtures of many chemical components. Moreover, devices and methods should be capable of fast chemical sensing, an attribute that may be especially useful in applications where traditional laboratory devices and analyses are impractical and/or require too much time to utilize. Sensors of devices would also be easy to produce to permit cost-effective manufacturing and available in wide diversity in order to enable a device to accurately detect and discriminate a large number of components in a vapor mixture. Ideally, particular sensors would be capable of a one-to-one correspondence with a given analyte. Moreover, devices may comprise sensors that may be regenerated (i.e., not irreversibly altered during analyte sensing) after a sensing event in order to minimize the need to replace sensors of a device or a device as a whole before subsequent analyses.

The disclosure provides devices and methods for chemical vapor sensing that are capable of achieving compact, fast chemical vapor sensing with high sensitivity and specificity. Devices generally comprise a plurality of sensors arranged in at least one array. Each sensor of a device may be addressable and capable of altered conductivity when in contact with a given component of a vapor mixture. Moreover, a sensor may be independently (or individually) addressable.

Devices may be used to execute sensing methods of the disclosure, either of which may be used in a range of applications to detect one or more chemical components in a vapor mixture.

An aspect of the disclosure provides an analyte sensing system, comprising: (a) an array of individually addressable sensors, wherein each individually addressable sensor of the array comprises a field effect transistor (FET) comprising a source and a drain and at least one nanostructure electrically coupling the source to the drain, which FET has a difference between a maximum current (Iₒₙ) and a minimum current (I_{off}) from about 30 nanoamps (nA) and 15000 nA at a source-drain voltage (V_{sd}) of about 100 mV; (b) a vapor distribution member comprising a fluid flow path in fluid communication with the array, wherein the vapor distribution member is configured to bring a fluid comprising one or more analytes in contact with the array; and (c) a computer processor in communication with the array of individually addressable sensors, wherein the computer processor is programmed to (i) receive electrical signals generated by the array upon contacting the array with the fluid comprising one or more analytes, and (ii) identify a given analyte of the one or more analytes.

In some examples, the Iₒₙ-I_{off} can be from about 500 nA to 3000 nA at a V_{sd} of about 100 mV. In some cases, the at least one nanostructure can be functionalized with a nucleic acid. The nucleic acid can be a single-stranded deoxyribonucleic acid. Moreover, in some cases, the array and vapor distribution member can be included in a housing. The computer processor may be external to the housing. In some cases, the at least one nanostructure can be a nanotube. Also, the at least one nanostructure can comprise a first nanostructure and a second nanostructure, wherein the first nanostructure is in contact with one of the source and the drain, but not both, and wherein the second nanostructure is in contact with the first nanostructure. In some cases, the second nanostructure can be in contact with the other of the source and the drain. In some cases, a mobile electronic device can comprise the computer processor.

An additional aspect of the disclosure provides a method for analyte detection, comprising: (a) providing a sensing system, comprising: (i) an array of individually addressable sensors, wherein each individually addressable sensor of the array comprises a field effect transistor (FET) comprising a source and a drain and at least one nanostructure electrically coupling the source to the drain, which FET has a difference between a maximum current (Iₒₙ) and a minimum current (I_{off}) from about 30 nanoamps (nA) and 15000 nA at a source-drain voltage (V_{sd}) of about 100 mV; (ii) a vapor distribution member comprising a fluid flow path in fluid communication with the array, wherein the vapor distribution member is configured to bring a fluid comprising one or more analytes in contact with the array; and (iii) a computer processor coupled to the array of individually addressable sensors, wherein the computer processor is programmed to (i) receive electrical signals generated by the array upon contacting the array with the fluid comprising one or more analytes, and (ii) identify a given analyte of the one or more analytes; and (b) using the vapor distribution manifold, bringing a fluid in contact with the array; and (c) using the computer processor, detecting the presence or absence of one or more analytes in the fluid.

In some cases, the Iₒₙ-I_{off} is from about 500 nA to 3000 nA at a V_{sd} of about 100 mV. In some cases, the at least one nanostructure is functionalized with a nucleic acid. The nucleic acid can be a single-stranded deoxyribonucleic acid. Moreover, in some cases, the array and vapor distribution member can be included in a housing. The computer processor may be external to the housing. In some cases, the at least one nanostructure can be a nanotube. In some cases, the at least one nanostructure can comprise a first nanostructure and a second nanostructure, wherein the first nanostructure is in contact with one of the source and the drain, but not both, and wherein the second nanostructure is in contact with the first nanostructure. In some cases, the second nanostructure can be in contact with the other of the source and the drain. In some cases, a mobile electronic device can comprise the computer processor.

An aspect of the present disclosure provides a chemical vapor sensing device, comprising a support and at least one array of individual sensors on the support. An individual sensor of the array can be capable of generating a response upon exposure to an analyte in a sample. The device can operate at an electrical power of less than or equal to about 1 watt at an analyte detection sensitivity of at least 1 part-per-billion.

Another aspect of the present disclosure provides a chemical vapor sensing device, comprising a support and at least one array of individual sensors on the support. An individual sensor of the array can be capable of generating a response upon exposure to an analyte in a sample. The device can discriminate at least about five analytes in the sample at a detection sensitivity of the analytes of at least 1 part-per-billion.

Another aspect of the present disclosure provides a chemical vapor sensing device, comprising a support and at least one array of individual sensors on the support. An individual sensor of the array is capable of generating a response upon exposure to an analyte in a sample. The device can operate at an electrical power of less than or equal to 1 watt and can discriminate at least about 5 analytes in the sample.

Another aspect of the present disclosure provides a chemical vapor sensing device, comprising a support an array of individual sensors on the support. The array can occupy a total area of no more than 100 mm² and an individual sensor of the array can be capable of generating (e.g., programmed to generate) a response upon exposure to an analyte in a sample. The device can discriminate at least about five analytes in the sample.

Another aspect of the present disclosure provides a chemical vapor sensing device comprising a support and an array of individual sensors on the support. An individual sensor of the array can be capable of generating a response upon exposure to an analyte in a sample. The individual sensor can be a single wall nanotube field-effect transistor (SWNT-FET) comprising a single-stranded DNA (ssDNA) functionalized single-walled carbon nanotube (SWNT) sensing element. The array can occupy a total area of no more than 100 mm².

In some of the various aspects, a device can sense at least about five analytes or at least about ten analytes. In some embodiments, a sample can be a mixture of one or more chemical components. In some embodiments, an array can have a volume of no more than 0.2 mm³. In some embodiments, a device can be configured for use through at least 10 sensing cycles without calibration or re-calibration. In some embodiments, a device can be configured for use through at least 20 sensing cycles without calibration or re-calibration or at least 100 sensing cycles without calibration or re-calibration. In some embodiments, individual sensors can comprise sensing elements that are carbon nanotubes (CNTs).

In some cases, sensing elements can be functionalized with one or more binding agents. The binding agent can be selected from the group consisting of a biopolymer, Naffion, polyimide, nanoporous silica, porphyrins, metallo-porphyrins, polyethyleneimide, conductive polymers, metallic nanoparticles, buckminsterfullerene, graphene flakes, graphene oxide flakes, reduced graphene oxide flakes, and combinations thereof. In some cases, the binding agent is a biopolymer such as, for example, a polynucleotide. The polynucleotide may comprise a single-stranded deoxyribonucleic acid (ssDNA). In some cases, the ssDNA can comprise at least 24 nucleotides. Moreover, in some cases, sensing elements can be functionalized with two or more different binding agents, wherein the different binding agents are isomers. The isomers may isomers of ssDNA.

In some embodiments, the diameter of CNTs can be in the range of 0.5 nm-5 nm. In some embodiments, CNTs may be catalytic chemical vapor deposition (CVD)-produced CNTs or may be solution-deposited CNTs. In some embodiments, CNTs may be single-walled carbon nanotubes (SWNTs) or multi-walled carbon nanotubes (MWNTs). The SWNTs, for example, may be individual SWNTs or bundled SWNTs. In some cases, the sensing elements can be assembled into single-walled carbon nanotube field-effect transistor (SWNT-FET) sensors.

In some embodiments, individual sensors in an array can be individually addressable. In some cases, an array may comprise at least about 1024 individual sensors or may comprise at most about 1024 individual sensors. In some embodiments, an array can have a sensor density of at least about sixteen individual sensors/mm². In some embodiments, an array can comprise at least ten different types of individual sensors or can comprise at least five different types of individual sensors. In some embodiments, a device can comprise at least five replicates of an individual sensor. In some embodiments, individual sensors can have a response range of −80% decrease to +80% increase of an initial sensor conductivity measured in an absence of analytes.

In some embodiments, a device may comprise a control assembly that is configured to communicate with an array. In some embodiments, the control assembly can comprise a processor that is in communication with an array. The control assembly may be capable of transmitting or receiving electronic signals through a computer network such as, for example, the Internet.

Another aspect of the present disclosure provides a method for analyzing a vapor-containing sample, comprising: a) providing a vapor sample to a chemical vapor sensing device that: i) operates at an electrical power of less than or equal to about 1 watt at an analyte detection sensitivity of at least 1 part-per-billion; ii) discriminates at least about five analytes in a sample at a detection sensitivity of the analytes of at least 1 part-per-billion; iii) operates at an electrical power of less than or equal to 1 watt and can discriminate at least about 5 analytes in the sample; and/or iv) comprise an array of individual sensors occupying a total area of no more than 100 mm² that can discriminate at least about five analytes in the sample. In some embodiments, the chemical vapor sensing device has any one, two, three or all of i), ii), iii) and iv). Next, a response of each the individual sensor in the device is generated when the individual sensors in the device are in contact with the vapor sample. With the aid of a computer processor coupled to the device, at least one chemical component of the vapor sample can be determined.

In some embodiments, with the aid of a processor coupled to the device, the responses obtained from the individual sensors of the device can be compared to at least one chemical fingerprint stored in a chemical fingerprint library to determine a chemical profile of the vapor sample. The chemical fingerprint library may contain at least about 30 chemical fingerprints. The chemical profile may be used to generate a diagnostic result. The diagnostic result may be used in a therapeutic decision.

In some embodiments, the diagnostic result relates to cancer, such as, for example, skin cancer, lung cancer, breast cancer, prostate cancer, cervical cancer, or combinations thereof. In some embodiments, the diagnostic result pertains to a pulmonary condition such as, for example, chronic obstructive pulmonary disease (COPD). In some embodiments, the diagnostic result pertains to an infectious disease or disorder such as, for example, tuberculosis, malaria, sinusitis, or combinations thereof. In some embodiments, the diagnostic result pertains to a metabolic disorder such as, for example, diabetes, keto-acidosis, kidney disease, liver disease, or combinations thereof. In some embodiments, the diagnostic result is obtained by sensing blood glucose levels. In some embodiments, the diagnostic result pertains to Epilepsy or a metabolic rate. The metabolic rate can be a metabolic rate of one or more macronutrients. Moreover, the metabolic rate, for example, can be assessed by sensing blood glucose level. In some embodiments, the diagnostic result pertains to alcohol intoxication. In some embodiments, the diagnostic result pertains to halitosis. In some embodiments, the diagnostic result pertains to air quality. In some embodiments, the diagnostic result pertains to terrorism.

In some embodiments, the vapor sample is human breath or atmospheric air. In some embodiments, the atmospheric air can be supplied to the device by an intake fan that is used to capture at least one analyte from at least one surface of a living organism. In some embodiments, the device communicates with a controller device. In some embodiments, the device can communicate with a database that stores a chemical fingerprint library. In some embodiments, the device can communicate with a mobile device.

Another aspect of the disclosure provides a chemical vapor sensing system, comprising: a sensing device comprising a fluid flow path in fluid communication with an array of individually addressable sensors, wherein the fluid flow path brings a vapor sample from a subject in contact with the array to detect the presence or absence of an analyte in the vapor sample at an analyte detection sensitivity of at least 1 part-per-billion; and a computer processor coupled to the sensing device, wherein the computer processor is programmed to correlate the presence or absence of the analyte in the vapor sample to the presence or absence of a disorder or disease condition in the subject.

In some embodiments, the disorder or disease condition is cancer such as, for example, skin cancer, lung cancer, breast cancer, prostate cancer, cervical cancer, or combinations thereof. In some embodiments, the disorder or disease condition is a pulmonary condition such as, for example, chronic obstructive pulmonary disease (COPD). In some embodiments, the disorder or disease condition is an infectious disease or disorder such as, for example, tuberculosis, malaria, sinusitis, or combinations thereof. In some embodiments, the disorder or disease condition is a metabolic disorder such as, for example, diabetes, keto-acidosis, kidney disease, liver disease, or combinations thereof. In some embodiments, the disorder or disease condition is Epilepsy. In some embodiments, the correlating is used to make a therapeutic decision.

An additional aspect of the disclosure provides an analyte sensor comprising a single wall nanotube field-effect transistor that has an Iₒₙ-I_{off} from about 30 nanoamps (nA) to 15000 nA at a source-drain voltage (V_{sd}) of about 100 mV. In some cases, the Iₒₙ-I_{off} is from about 500 nA to 3000 nA at a V_{sd} of about 100 mV.

Another aspect of the present disclosure provides a chemical vapor sensing device comprising an array of sensors. The array can operate at an analyte detection sensitivity of at least 1 part-per-billion. The device can be coupled to a system capable of correlating the presence of the analyte in a vapor sample to the presence of a disorder or disease condition.

Another aspect of the present disclosure provides a computer readable medium comprising machine-executable code that, upon execution by one or more computer processors, implements any of the methods above or elsewhere herein.

Another aspect of the present disclosure provides a computer system that comprises one or more computer processors and memory comprising machine-executable code that, upon execution by the one or more computer processors, implements any of the methods above or elsewhere herein.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “FIG.” and “FIGS.” herein), of which:

FIG. 1 shows an example of the difference in current generated between the source and the drain electrode as a function of gate voltage for a single wall nanotube field-effect transistor (SWNT-FET) sensor comprising a non-functionalized SWNT sensing element and a SWNT-FET sensor comprising a single-stranded DNA (ssDNA)-functionalized SWNT sensing element;

FIG. 2 schematically illustrates an example SWNT-FET sensor;

FIG. 3A schematically illustrates a macroscale view of an example SWNT-FET sensor array.

FIG. 3B schematically illustrates, in a microscale view, the arrangement of an individual sensor of the example sensor array schematically illustrated in FIG. 3A;

FIG. 4 schematically illustrates an example process used to construct an example SWNT-FET sensor for use in a sensor array;

FIG. 5 is a conceptual schematic of an exemplary control assembly;

FIG. 6 schematically illustrates an example combination of a sensor array with readout electronics into a single housing, wherein the housing is arranged such that it may interface with a mobile device;

FIG. 7 schematically illustrates several examples of a chemical fingerprint;

FIG. 8 schematically illustrates a method for using a chemical vapor sensing device to diagnose a disorder or condition and/or make a therapeutic decision;

FIG. 9 provides response trajectories with respect to time for several example sensing experiments, wherein several SWNT-FET sensors, each comprising an isomeric ssDNA functionalized SWNT sensing element, contact dimethyl methylphosphonate (DMMP) and methanol;

FIG. 10 provides response trajectories with respect to chemical species concentration for two sets of example sensing experiments, wherein a SWNT-FET comprising an ssDNA functionalized SWNT sensing element contacts a set of structurally similar organic acids and a set of structurally similar aldehydes;

FIG. 11 provides response trajectories with respect to chemical species concentration for several example sensing experiments, wherein a SWNT-FET comprising an ssDNA functionalized SWNT sensing element contacts a set of three different isomeric species;

FIG. 12 provides response trajectories with respect to chemical species concentration for two sets of example sensing experiments, wherein a SWNT-FET comprising an ssDNA functionalized SWNT sensing element contacts a set of limonene enantiomers and a set of carvone enantiomers;

FIG. 13 shows a computer system that is programmed or otherwise configured to implemented methods of the present disclosure;

FIGS. 14A and 14B are schematic exploded top and bottom views, respectively, of a sensing system. FIGS. 14C, 14D and 14E are perspective cross-sectional side views of the system of FIGS. 14A and 14B. FIG. 14F is a perspective side view of the system of FIGS. 14A and 14B. FIG. 14G is a cross-sectional side view of the system of FIGS. 14A and 14B; and

FIGS. 15A, 15B and 15C schematically illustrate various views of a sensing system.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

The term “chemical sensor,” as used herein, generally refers to a device that is capable of generating a response when in contact with or proximity to one or more chemical species.

The term “analyte,” as used herein, generally refers to a substance that is (or whose chemical constituents are) being identified, detected or measured by a sensor, or is identifiable, detectable, or measurable by the sensor. An analyte may be a component of a fluid (e.g., vapor) sample that is sensed by a chemical sensor. Non-limiting examples of analytes include nucleic acids, proteins, small organic compounds, or chemical components of organisms. Examples of analytes include, without limitation, alcohols, carboxylic acids, aldehydes, ketones, alkanes, alkenes, alkynes, aromatics, nitrogen oxide (e.g., NO, NO₂), carbon monoxide, carbon dioxide, volatile organic compounds, water, hydrogen peroxide, sulfur oxides (e.g., SO₂), ammonia, H₂S, organic acids and inorganic acids.

The term “nanoparticle,” as used herein, generally refers to a structure (e.g., nanostructure) with at least one dimension from at least a nanometer to a hundred nanometers or a micron (1000 nanometers (nm)). A nanoparticle can have a major dimension that is less than or equal to 1000 nanometers nm, 500 nm, 100 nm, or 10 nm.

The term “binding agent,” as used herein, generally refers to a chemical species associated with a chemical sensor that is capable of binding to, associating with, or interacting with an analyte.

The term “individually addressable,” as used herein, generally refers to a one-to-one correspondence between an individual sensor and the response of the individual sensor that may be detected.

The term “detection sensitivity,” as used herein, generally refers to the lowest amount or concentration at which a device may sense a given analyte.

The term “chemical fingerprint,” as used herein, generally refers to a signature of a chemical species that comprises the individual responses of at least a subset of a device's individual chemical sensors when the individual chemical sensors are in contact with the chemical species.

The present disclosure provides devices and methods for chemical vapor sensing that are capable of achieving compact, fast chemical vapor sensing with high sensitivity and specificity. Devices may comprise a plurality of chemical sensors arranged in at least one array. Each sensor of a device may be addressable and capable of altered conductivity when in contact with (or proximity to) a given component of a vapor mixture. Devices of the disclosure may be used to execute sensing methods of the disclosure that may be useful in a range of applications to detect one or more chemical components in a vapor mixture.

Devices of the present disclosure can include a field effect transistor (FET) comprising a source and a drain, and a sensing element electrically coupling the source and the drain. The sensing element can include one or more nanostructures, such as nanotubes. The nanotubes can be hollow. Examples of nanotubes include carbon nanotubes. A sensing element can be functionalized such that it is sensitive to one or more analytes. The sensing element can be functionalized by one or more nucleic acid molecules, such as ribonucleic acid (RNA), deoxyribonucleic acid (DNA), or variants and/or combinations thereof. A nucleic acid molecule can be single-stranded.

Devices of the present disclosure can be part of (e.g., integrated in) sensing systems. A sensing system can include a computer system comprising a computer processor or other logic. The sensing system can include a housing that comprises an array of individual sensors, and a fluid distribution manifold that comprises a fluid flow path that is in fluid communication with the array. The fluid flow path can bring a fluid comprising one or more analytes in contact with the array for sensing. The computer system can be in the housing or external to the housing. In some examples, the computer system is or is integrated in a mobile electronic device (e.g., Apple® iPhone®, Apple® iPad®, Android-enabled Smart phone or tablet personal computer), and the housing is coupled to the mobile electronic device. The mobile electronic device can be a portable electronic device. The mobile electronic device can include an energy storage device (e.g., battery). The mobile electronic device can have a weight that is less than or equal to about 4000 grams (g), 3000 g, 2000 g, 1000 g, 500 g, 400 g, 300 g, 200 g, 100 g, or 50 g. The mobile electronic device may be capable of being operated by a user, in some cases while the user is moving from one point to another. The mobile electronic device may be a handheld device (e.g., iPhone®).

Devices provided herein may be capable of fast chemical sensing, with high sensitivity and/or specificity. A chemical vapor sensing device may be useful for the rapid detection, and, possibly, quantification of one or more chemical species in a vapor sample, without substantial sample processing prior to sensing. The devices disclosed herein broadly include at least one array of chemical sensors such that the sensors may be brought into contact with a vapor sample. The sensors of the array may be capable of a response when sensor contact with an analyte in the vapor sample is made. Sensor responses are generally evaluated with one or more on-board device components or downstream devices that may be capable of analyzing sensor responses and interpreting an analysis into outputs useful to an end user. The arrangement of the sensors in an array of a device and additional and/or optional device components may be further exemplified by specific devices. Moreover, devices may vary from one another in their operating requirements and/or operating performance. Various, non-limiting examples of components that may be included as part of various devices, the arrangement of such components, the operating requirements for devices, and the operating capabilities of devices are further outlined elsewhere herein.

### Devices

An aspect of the disclosure provides a chemical sensor comprising a sensing element disposed between electrodes that form electrical contacts to the sensing element. The sensing element in some examples is a nanostructure or nanoparticle, such as a nanotube (e.g., carbon nanotube (CNT)).

### Sensors and Sensing Elements

A chemical sensor may comprise a sensing element. In some cases, a sensing element may be the only component of a chemical sensor; in other cases, a sensing element may be a component among a plurality of components (e.g., sensing elements) of a chemical sensor—that is, a chemical sensor can include multiple sensing elements. The use of a sensing element in a device may depend on a number of factors with non-limiting examples that include the sensing element's capability to sense an analyte of interest and generate a response; whether a desired binding agent can be attached to the surface of a sensing element; whether a desired, associated binding agent, that does not attach to the surface of the sensing element can still assume a position close enough to the surface of the sensing element such that a response may be generated; or combinations thereof.

A chemical sensor may include one or more nanoparticles disposed between electrodes. Nanoparticles, for example, may function, in whole or part, as sensing elements when disposed to bridge two electrical contacts. In some cases, a nanoparticle is capable of generating a response that is manifested as an altered electronic state (e.g., such as altered conductivity) when in contact with one or more analytes. Some nanoparticles may be attractive sensing elements due to their high surface area-to-volume ratios that may result in more numerous interactions with analytes and/or higher loading of associated binding agents used to bind analytes. Nanoparticles used as sensing elements, for example, may be elongated, cylindrical shaped nanoparticles that generally possess nanometer-length scale diameters and lengths of up to 100 microns. Non-limiting examples of such nanoparticles include nanotubes and nanowires. Nanotubes are generally hollow whereas nanowires are generally solid. Common nanotubes, for example, are carbon nanotubes (CNTs). Common nanowires, for example, are nanorods and organic and inorganic conductive and semiconducting polymer nanowires. In general, nanotubes and nanowires may be grown on, or applied to, surfaces of a substrate such that they are assembled to bridge two electrical contacts, wherein bridging completes an electric circuit between the two electrical contacts.

Devices of the present disclosure can include a chemical sensor comprising a CNT sensing element. CNTs may be classified by the method used to produce them with non-limiting examples of such methods that include arc discharge, laser ablation, and high-pressure carbon monoxide disproportionation (HiPco). Alternatively, vapor deposition methods, such as chemical vapor deposition (CVD) or atomic layer deposition (ALD) may be used. In an example, metal-catalyzed chemical vapor deposition (CVD) methods may be used to grow CNTs on substrate surfaces. There are various examples of catalyzed CVD synthetic methods that may be used to produce CNTs. See, for example, Kong, et al., “Synthesis of Individual Single-Walled Carbon Nanotubes on Patterned Silicon Wafers”, Nature 395, 878-881 (1998); Kong, et al., “Chemical Vapor Deposition of Methane for Single-Walled Carbon Nanotubes” Chem. Phys. Lett. 292, 567-574 (1998), both incorporated herein by reference. Moreover, solution deposited and dip deposited methods may be used to apply CNTs to a substrate. Additionally, CNTs may be synthesized in varying morphologies, with non-limiting examples that include single-walled carbon nanotubes (SWNTs) and multi-walled carbon nanotubes (MWNTs). SWNTs are generally single sheets of graphene rolled into a seamless tube, whereas MWNTs are a concentric arrangement of one or more SWNTs that differ in diameter. Furthermore, CNTs may also be synthesized such that individual CNTs are separate entities or may be synthesized such that a grouping of CNTs is bundled together.

CNTs included as sensing elements may have various sizes and configurations. CNT sensing elements may be from about 500 nanometers (nm) in length to about 20 microns in length. In some cases, CNT sensing elements are from about 3 micrometers (microns) to 20 microns in length. In other cases, CNT sensing elements are from about 5 microns to 20 microns in length. In still other cases, CNT sensing elements are from about 10 microns to 20 microns in length. In still other cases, CNT sensing elements are at least about 0.5, 1, 2, 3, 4, 5, 6, 7, 8, 9, 10, 11, 12, 13, 14, 15, 16, 17, 18, 19, or 20 microns in length. In still other cases, CNT sensing elements are at most about 0.5, 1, 2, 3, 4, 5, 6, 7, 8, 9, 10, 11, 12, 13, 14, 15, 16, 17, 18, 19, or 20 microns in length. CNT's may be provided longitudinally from a first electrode to a second electrode, or may be provided in an interlocking matrix.

CNT sensing elements may have various diameters. CNT sensing elements may be, for example, from about 0.1 nm to 10 nm in diameter. In other examples, CNT sensing elements may be from about 0.5 nm to 5 nm in diameter. In other examples, CNT sensing elements may be from about 0.5 nm to 3 nm in diameter. In still other examples, CNT sensing elements may be at least about 0.5, 1.0, 1.5, 2.0, 2.5, 3.0, 3.5, 4.0, 4.5, or 5.0, 6.0, 7.0, 8.0, 9.0, 10.0, 15.0, or 20.0 nm in diameter. In still other examples, CNT sensing elements may be at most about 0.5, 1.0, 1.5, 2.0, 2.5, 3.0, 3.5, 4.0, 4.5, or 5.0, 6.0, 7.0, 8.0, 9.0, 10.0, 15.0, or 20.0 nm in diameter.

In some cases, sensors (or sensing devices) of the present disclosure may be used with hybrid particles, such as SWNT-metal oxide hybrids. Such hybrids can include SWNT-TiOₓ (wherein ‘x’ is a number greater than 0) hybrids, such as SWNT-TiO₂ hybrids. Such hybrid particles are described in Mengning Ding, Dan C. Sorescu, and Alexander Star, “Photoinduced Charge Transfer and Acetone Sensitivity of Single-Walled Carbon Nanotube—Titanium Dioxide Hybrids,” J. Am. Chem. Soc., 2013, 135 (24), pp 9015-9022, which is entirely incorporated herein by reference.

### Functionalized Sensing Elements

A sensing element may be functionalized with one or more binding agents. Functionalization with a binding agent may, for example, render a sensing element capable of specifically immobilizing or interacting with, via the binding agent, a desired analyte. Binding, for example, may improve sensor response, or, in some cases, may be required for sensor response. Careful design of a binding agent may enhance the sensitivity and specificity of a particular sensing element as well as enhance the potential range of analytes that may generate a response from the sensing element.

A variety of agents may functionalize a sensing element and serve as binding agents. A binding agent may associate with a sensing element via covalent bonds or by non-covalent mechanisms with non-limiting examples that include van der Waals forces, hydrophobic interactions, ionic bonds, and hydrogen bonds. Non-limiting examples of binding agents include biopolymers, Naffion, polyimide, nanoporous silica, porphyrins, metallo-porphyrins, polyethyleneimide, conductive polymers, metallic nanoparticles, buckminsterfullerene (i.e., “bucky balls”), graphene flakes, graphene oxide flakes, reduced graphene oxide flakes, and combinations thereof.

Both manual and automated processes may be used to functionalize a sensing element with a binding agent and/or apply any other fluid agent. For example, a manual approach may include applying a solution of binding agent to a sensing element(s) with the aid of a manually-operated dispensing device (e.g., a pipette). One or more drops of binding agent solution may be applied to the sensing element, with the treated sensing elements then incubated for a suitable duration. After incubation, any remaining fluid may be removed by evaporation, such as, for example, using a vacuum or by applying an inert gas (e.g., nitrogen or argon) to the sensing element. In another example, excess fluid is removed using a manner that is the same or similar as it was applied. Excess drops of fluid can be removed by the same manner used to apply drops. In some cases, excess drops can be removed by applying an inert gas or using a vacuum

Alternatively, an automated process may be used. Automated processes may rely on one or more robotic dispensing devices for functionalization of sensing element(s) with binding agent. A robotic dispensing device, for example, may be programmed to dispense a specific type of binding agent, to dispense a metered amount of binding agent, and/or to dispense binding agent to a particular region(s) of a sensor (e.g., a region comprising sensing elements). In some examples, a robotic dispensing device may comprise a pipette or capillary device (e.g., a capillary pin), either of which may aid in dispensing binding agent or other fluid. Moreover, a robot may be programmed for repetitive dispensing, such that functionalization of sensing elements in a plurality of sensors is achieved. Automated methods, such as the use of robotic dispensing devices, may be particularly useful in achieving high-throughput production of a sensor array (as described herein) comprised of a plurality of sensors with accuracy and precision. Moreover, robotic dispensing devices may also be useful in cases where amounts of binding agent, too small to be measured accurately manually, can be accurately and precisely applied to sensing elements.

Moreover, the physical characteristics of device surfaces may be tailored such that functionalization of SWNT sensing elements is achieved uniformly. For example, device surfaces may be hydrophobic. Hydrophobic surfaces can resist the deposition of hydrophilic materials, resulting in the isolation of hydrophilic materials to appropriate hydrophilic surfaces. For example, a device may comprise hydrophobic surfaces in order to aid in uniformly coating SWNT sensing elements with a binding agent or coating other hydrophilic surfaces during device fabrication. In some examples, a surface is rendered hydrophobic by the silanization of a silicon oxide (e.g., SiO₂) surface, such as upon exposure to octadecyltrichlorosilane (CH₃(CH₂)₁₇SiCl₃).

In some examples, a binding agent is a biopolymer. Biopolymers are naturally occurring polymers of biologically relevant monomers such as, for example, nucleotides, monosaccharides, amino acids, fatty acids, or combinations thereof with non-limiting examples that include polynucleotides, polypeptides, nucleic acid-polypeptide complexes, carbohydrates, aptamers, ribozymes, and all homologs, analogs, conjugates, or derivatives thereof, as well as mixtures thereof. A biopolymer may assume primary, secondary, tertiary, and/or quaternary structure that is capable of binding one or more analytes. In some examples, a biopolymer may comprise one or more specific sequences of monomers. A biopolymer may comprise a specific sequence or a specific sequence may be included as part of a larger sequence (e.g., a 21-mer specific sequence included in a biopolymer of 42 monomers). In other examples, a biopolymer may comprise a random sequence of monomers. A biopolymer may comprise a random sequence or a random sequence may be included as part of a larger sequence (e.g., a 21-mer random sequence included in a biopolymer of 42 monomers). For example, a biopolymer for sensing a given analyte can be 100 base pairs in length, but include a ten base-pair sequence that is directed to (e.g., sensitive to) the analyte.

In some examples, a biopolymer is a polynucleotide. A polynucleotide generally refers to any polyribonucleotide polydeoxyribonucleotide, which include, for example, ribonucleic acid (RNA) and deoxyribonucleic acid (DNA), respectively. Moreover, a polynucleotide may comprise a single-stranded polyribonucleotide (e.g., single-stranded RNA (ssRNA)) or polydeoxyribonucleotide (e.g., single-stranded DNA (ssDNA)), a double-stranded polyribonucleotide (e.g., double-stranded RNA (dsRNA)) or polydeoxyribonucleotide (e.g., (dsDNA)), or a combination thereof (e.g., RNA or DNA that is a mixture of single- and double-stranded regions; hybrid molecules comprising DNA and RNA, either or both of which may be single-stranded or double-stranded). In addition, polynucleotides may also comprise triple-stranded regions of RNA, DNA, or both RNA and DNA. Furthermore, polynucleotides may comprise DNA or RNA nucleotides which have been chemically modified. Polynucleotides may include chemically, enzymatically or metabolically modified polynucleotides that may be typically found in nature, viruses, cells, or produced synthetically. Common sites of modification, for example, include the deoxyribose sugar unit of a DNA nucleotide or the ribose sugar unit of an RNA nucleotide. Such modifications to the deoxyribose sugar unit of a DNA nucleotide or ribose sugar unit of an RNA nucleotide may be made, for example, to impart better stability on a given polynucleotide. Moreover, polynucleotides, for example, may be relatively short nucleic acid biopolymers, often referred to as oligonucleotides.

Polynucleotides may be of varied nucleotide composition. In some examples, a polynucleotide may comprise a specific nucleotide sequence. In other examples, a polynucleotide may comprise a random nucleotide sequence. In still other examples, a polynucleotide may comprise a sequence of a single type of base, two types of bases, three types of bases, four types of bases, or more.

A polynucleotide, such as, for example, ssDNA, may function as a linker that couples a binding agent to a sensing element. A linker strategy, for example, may be necessary in cases where a desired binding agent does not readily couple to a sensing element without further modification. In some examples, a polynucleotide couples a separate polynucleotide or other binding agent to a sensing element. In other examples, a polynucleotide functions as a binding agent and a self-linker, such that part of the polynucleotide is used for association with a sensing element and the same part or other parts of the molecule are used for binding one or more analytes. For example, ssDNA may function as a linker, a binding agent, or both in cases where it functionalizes an SWNT sensing element. The bases (e.g., adenine, guanine, cytosine, and thymine) of the ssDNA, for example, may readily adsorb to the surface of the sidewall of the SWNT via pi-pi stacking interactions with the SWNT surface. Functioning as a linker, the ssDNA may be modified with another polynucleotide and/or other biopolymer, either pre- or post-adsorption of the ssDNA onto the surface of the SWNT sensing element. For example, a desired RNA binding agent, that does not readily associate with an SWNT sensing element, may be modified with an ssDNA to couple the RNA to the SWNT sensing element. Other coupling strategies may be utilized to couple a binding agent to a sensing element in cases where a polynucleotide cannot be used as a linker and the binding agent cannot readily couple to a desired sensing element. See, for example, Hermanson, G. T., BIOCONJUGATE TECHNIQUES (Academic Press, San Diego, 1996), which is entirely incorporated herein by reference. Alternatively, the ssDNA, may pi-pi associate with the SWNT sensing element and also function as a binding agent. In examples where a sensing element is an ssDNA-functionalized SWNT, association of the SWNT with the ssDNA may produce a positive electrostatic potential at the surface of the SWNT.

The variety of biopolymer types and the variety of assemblies (e.g., one-, two-, three-dimensional structure of a biopolymer, specific monomer composition of a biopolymer, sequencing of component monomers such that isomers may be considered separate binding agents, number of constituent monomers of a biopolymer) each type of biopolymer may assume provides for a large library of specific biopolymer binding agents. Each binding agent in the library may be capable of functionalizing a sensing element giving rise to a wide diversity of possible unique sensing elements. Consequently, the functionalization of a sensing element with a unique biopolymer binding agent or combination of unique biopolymer binding agents or other binding agents may generally render the sensor comprising the functionalized sensing element unique. Sensor diversity of a device may be useful in enhancing the sensitivity and specificity of the device for a given analyte as well as enhance the potential range of analytes that may be detected with the device.

A variety of methods, such as, for example, directed evolution, may be used to design biopolymer molecules that are capable of binding specific target analytes. Directed evolution may generally involve utilizing principles of natural selection to evolve biopolymers, such as proteins or nucleic acids, with desirable properties. Consequently, biopolymers that functionalize sensing elements may be designed such that they bind to a single specific analyte, multiple specific analytes, sets of specific analytes, or combinations thereof.

A sensing element may be functionalized with varied numbers of binding agents. For example, the number of binding agents functionalizing a sensing element may be at least about 1,000,000 binding agents. In other examples, the number of binding agents functionalizing a sensing element may be at least about 100,000 binding agents. In other examples, the number of binding agents functionalizing a sensing element may be at least about 10,000 binding agents. In other examples, the number of binding agents functionalizing a sensing element may be at least about 1,000 binding agents. In still other examples, the number of binding agents may be at least about 1, 10, 100, 1,000, 10,000, 100,000, or 1,000,000 binding agents.

A sensing element may be functionalized with varied numbers of different binding agents. For example, the number of different binding agents functionalizing a sensing element may be at least about 10,000 different binding agents. In other examples, the number of different binding agents functionalizing a sensing element may be at least about 1,000 different binding agents. In other examples, the number of different binding agents functionalizing a sensing element may be at least about 10,000 different binding agents. In other examples, the number of different binding agents functionalizing a sensing element may be at least about 1,000 different binding agents. In still other examples, the number of different binding agents may be at least about 1, 10, 100, 1,000, 10,000, 100,000, or 1,000,000 different binding agents.

Moreover, a sensing element may be functionalized with binding agents of varied numbers of constituent monomer units. For example, a binding agent functionalizing sensing element may comprise from about 2 monomer units to 1000 monomer units. In other examples, a binding agent may comprise from about 2 monomer units to 100 monomer units. In still other examples, a binding agent may comprise from about 2 monomer units to 50 monomer units still other examples, a binding agent may comprise about 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 60, 70, 80, 90, 100, 125, 150, 175, 200, 250, 350, 400, 500, 600, 700, 800, 900, or 1000 monomer units.

In some examples, a binding agent functionalizing a sensing element may comprise at most about 2 monomer units 1000 monomer units. In other examples, a binding agent may comprise at most about 2 monomer units to 100 monomer units. In still other examples, a binding agent may comprise at most about 2 monomer units to 50 monomer units. In still other examples, a binding agent may comprise at most about 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 60, 70, 80, 90, 100, 125, 150, 175, 200, 250, 350, 400, 500, 600, 700, 800, 900, or 1000 monomer units.

In some examples, a binding agent functionalizing a sensing element may comprise at least about 2 monomer units to 1000 monomer units. In other examples, a binding agent may comprise at least about 2 monomer units to 100 monomer units. In still other examples, a binding agent may comprise at least about 2 monomer units to 50 monomer units. In still other examples, a binding agent may comprise at least about 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 60, 70, 80, 90, 100, 125, 150, 175, 200, 250, 350, 400, 500, 600, 700, 800, 900, or 1000 monomer units.

A variety of methods, such as, for example, directed evolution, may be used to design biopolymer molecules that are capable of binding specific target analytes. Directed evolution may generally involve utilizing principles of natural selection to evolve biopolymers, such as proteins or nucleic acids, with desirable properties. Consequently, biopolymers that functionalize sensing elements may be designed such that they bind to a single specific analyte, multiple specific analytes, sets of specific analytes, or combinations thereof.

### Single-Wall Carbon Nanotube Field Effect Transistor (SWNT-FET) Sensors

Devices of the present disclosure may include one or more binding agent-functionalized SWNT (BF-SWNT) sensing elements that are arranged into a SWNT field effect transistor (SWNT-FET) to form one or more chemical sensors of the device. SWNT-FETs comprising a BF-SWNT sensing elements can function as high-sensitivity chemical sensors, such that sensor responses are manifested as conductivity changes in the component BF-SWNT sensing elements. In general, SWNT-FET devices lacking BF-SWNTs (i.e., instead, comprising bare SWNTs) may not exhibit a response to most analytes. On the other hand, an SWNT-FET sensor comprising one or more BF-SWNT sensing elements may exhibit detectable responses when one or more of its BF-SWNT sensing elements binds an analyte. A BF-SWNT may be tailored to a given analyte. For example, a BF-SWNT may be sensitive to alcohol but not other types of analytes. Without limitation to any particular mechanism or theory of operation, the electrical conductivity of a SWNT sensing element may be sensitive to charged species, such as, for example, a binding agent, bound near the SWNT sidewall. Such charged species can affect the local electric field near the conduction channel formed by the SWNT. The binding of an analyte to a binding agent that functionalizes an SWNT sensing element may further alter the conductivity of the SWNT-binding agent composite. Such a change in conductivity upon binding of an analyte may be recorded as a sensing signal. The change of conductivity in a given BF-SWNT sensing element of a SWNT-FET sensor may differ, such, as for example, in sign and/or magnitude, for differing analytes. Similarly, different conductivity changes may be observed in BF-SWNT sensing elements comprising different binding agents when contacting the same analyte. Such response differences may be due to a number of factors related to the SWNT-bound binding agent such as, for example, the binding agent used, the sequence (in whole or part) of a polymeric binding agent (e.g., the sequence of a biopolymer), the physical characteristics of the binding agent used, the point of attachment of a binding agent, the specific effects the binding agent has on its associated SWNT, the affinity of the binding agent for a given analyte, the interaction of the binding agent's electric field with that of the analyte, and combinations thereof.

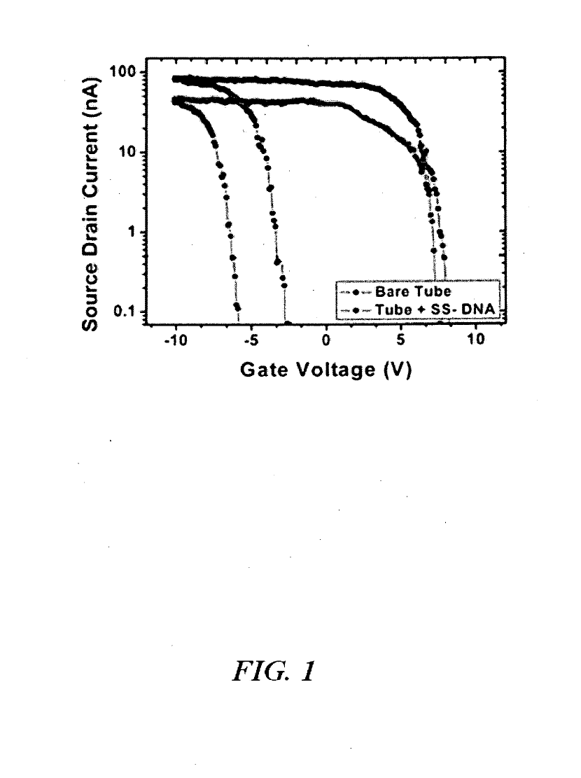

An example of the effects of a binding agent on the conductivity of its associated SWNT sensing element is shown in FIG. 1. In FIG. 1, current is plotted as a function of applied gate voltage (V_{G}) for a SWNT-FET comprising a bare SWNT sensing element not functionalized with any material and for a SWNT-FET comprising a materially identical SWNT sensing element functionalized with ssDNA. The plots for each SWNT-FET show different current trajectories as a function of gate voltage suggesting the presence of binding biopolymer alters the conductivity properties of an SWNT sensing element arranged in a SWNT-FET.

A SWNT-FET sensor may comprise a substrate that may or may not be semiconducting; an insulating layer; source and drain electrodes; and, in contact with each of the source and drain electrodes, at least one BF-SWNT sensing element. Moreover, the SWNT-FET may be adapted to have a V_{G} applied to the substrate and a bias voltage (V_{B}) applied between the source and drain electrodes. The SWNT is then capable of conducting current (I) between the source and drain electrodes that may be modulated by the electric field strength local to the BF-SWNT sensing element. In some cases, the BF-SWNT may be semiconducting.

With the application of a bias voltage between the source and drain electrodes, the gate voltage may be swept across a range of gate voltages (including those described herein) and the current generated between source and drain electrodes measured. The sweep frequency may vary depending upon the particular device. For example, the sweep frequency may be at least about 0.1, 0.5, 1.0, 1.5, 2.0, 3.0, 4.0, 5.0, 10, 15, 20, 30, 40, 50, 60, 70, 80, 90, 100, 500, 1000, 5000, 10000, 50000, 100000, 500000, 1000000, 5000000, or 10000000 Hertz (“Hz”). An I-V curve, similar to that shown in FIG. 1, may be generated from the voltage sweep. From this curve a fit may be performed using the currents recorded at various sweep voltages as described above. The number of recorded currents (and, thus, points used for the fit) may vary. In some cases, a 2-point, 3-point, 4-point, 5-point, 6-point, 7-point, 8-point, 9-point, 10-point, 11-point, 12-point, 13-point, 14-point, or 15-point fit may be performed. Fitting may provide a set of parameters that can be used to identify a particular chemical species, by comparison with reference parameters. The number of parameters calculated may vary, depending on the particular fitting algorithm used. In some cases, the number of parameters is at least 2, 3, 4, 5, 6, 7, 8, 9, 10, 15, 20, 25, 30, 35, 40, 45, or 50 parameters.

After fitting and extraction of parameters, a data reduction algorithm may be used to reduce the extracted parameters to their non-redundant dimensions. For example, a data reduction algorithm may be a principle component analysis.

Applied V_{B} requirements may vary. For example, V_{B} may be from about 0.1 mV to about 10 V. In some examples, V_{B} may be from about 1 mV to about 1 V. In other examples, V_{B} may be from about 10 my to about 500 mV. In other examples, V_{B} may be from about 0.1 mV, 1 mV, 5 mV, 10 mV, 20 mV, 30 mV, 40 mV, 50 mV, 60 mV, 70 mV, 80 mV, 90 mV, 100 mV, 200 mV, 300 mV, 400 mV, 500 mV, 600 mV, 700 MV, 800 MV, 900 mV, 1 V, or 10 V.

Applied V_{G} requirements may vary both in magnitude and sign. For example, V_{G} may be from about −50V to about +50V. In other examples, V_{G} may be from about −10V to about +10V. In other examples, V_{G} may be from about −5V to about +5V. In other examples, V_{G} may be from about −1V to about +1V. In still other examples, V_{G} may be about −50V, −40V, −30V, −20V, −10V, −5V, −1V, +1V, +5V, +10V, +20V, +30V, +40V, or +50V.

An individual sensor of the present disclosure can have a current-voltage (IV) curve that provides an output current as a function of applied (modulated) gate voltage. A given IV curve is characterized by an on current (Iₒₙ), which is the maximum current of the sensor in an ‘on’ state, and an off current (I_{off}), which is the minimum current of the sensor. I_{off} may have a non-zero value. The resistance at a given state (e.g., on or off) can be determined from the relationship R=V_{sd}/Ion, where ‘V_{sd}’ is the voltage applied between the source and the drain, which is typically constant.

A sensor of the present disclosure can have an Iₒₙ from 1 nano amps (nA) to 10000 nA, or 10 nA to 5,000 nA, or 100 nA to 4000 nA, or 300 nA to 3000 nA, or 500 nA to 3000 nA. A difference between Iₒₙ and I_{off} of the sensor, or Iₒₙ-I_{off}, can be from 1 nA to 15000 nA, or 10 nA to 10000 nA, or 30 nA to 5000 nA at V_{sd} of 100 mV. In some examples, a sensor has an Iₒₙ-I_{off} between about 30 nA to 15000 nA at a V_{sd} of 100 mV, or about 500 nA and 1500 nA at a V_{sd} of 100 mV.

A sensor of the present disclosure can have a ratio of Rₒₙ and R_{off}, or Rₒₙ/R_{off}, from about 0.001 to 1000, or 1 to 500, or 10 to 100. In an example, Rₒₙ/R_{off} is from about 5 and 15.

Sensors of the present disclosure can be employed to sense one or more analytes in a fluid. During sensing by an individual sensor (e.g., as part of an array of individual sensors), the individual sensor is exposed to the fluid, and the gate voltage (Vg) is modulated and an output current of the individual sensor (source/drain current) is detected to generate an IV curve. The curve can be generated from at least 4, 5, 6, 7, 8, 9, 10, 15, 20, 30, 40, 50, 60, 70, 80, 90, 100, or 500 current measurements upon modulating Vg of the individual sensor. The Iₒₙ and I_{off} can then be determined for the IV curve. The IV curve (including discrete current data points) can then be normalized by the Iₒₙ-I_{off}. This can provide an IV curve for a given sensor that may be unique to a given analyte in the fluid sample. The IV curves can be compared by a computer processor or other logic to IV curves for known samples to determine an identity of the one or more analytes in the fluid sample.

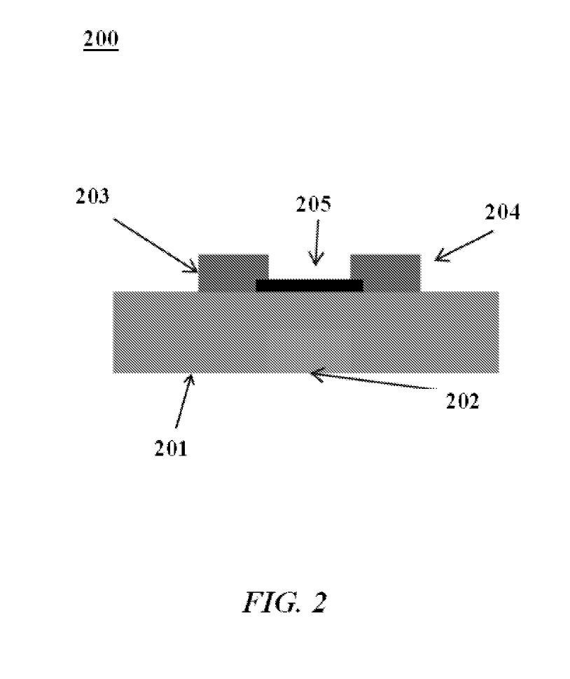

An example SWNT-FET sensor 200 is shown in FIG. 2. A dielectric layer 201 rests upon a substrate 202. The dielectric layer 201 may be silicon dioxide or other electrically insulative material. On the surface of the dielectric layer 201 are a drain electrode 203 and a source electrode 204. Drain electrode 203 and source electrode 204 are electrically connected via a SWNT layer 205. SWNT layer 205 comprises one or more SWNTs that have one end in electrical contact with the drain electrode 203 and the other end in electrical contact with the source electrode 204. These SWNTs serve as the sensing elements of the SWNT-FET sensor. The SWNTs of SWNT layer 205 are functionalized with a biopolymer, such as, for example, ssDNA. Substrate 202 serves as a back gate that may modulate the conductivity of the conduction channels formed between drain electrode 203 and source electrode 204 by the SWNTs of SWNT layer 205. Moreover, substrate 202 may be constructed of a semiconducting or conducting material or compounds of such materials, with non-limiting examples that include silicon, germanium, gallium, indium, aluminum, gold, copper, diamond, nitride, arsenide, and or combinations thereof. Drain electrode 203 and source electrode 204 may be constructed of an electrically conductive metal such as gold, silver, aluminum, chromium, titanium, copper, tantalum, rhodium, cobalt, tungsten, platinum, palladium, or combinations thereof. Alternatively, drain electrode 203 and source electrode 204 may also be constructed of appropriately doped semiconductor materials.

While in some cases a SWNT-FET may comprise a single SWNT disposed between source and drain electrodes, a SWNT-FET can comprise a plurality of SWNTs disposed between the two electrodes. The density of SWNTs of a SWNT-FET may have important consequences for a number of factors related to sensor functionality, with non-limiting examples that include signal variability and signal noise.

The density of SWNTs disposed on the surface of a SWNT-FET may vary depending on, for example, methods used to grow SWNTs on the surface of the SWNT-FET. In some cases, scanning electron microscopy (SEM) can be used to determine the density of SWNTs in a SWNT-FET and density can be measured as the percentage of the SWNT-FET surface occupied by SWNTs. For example, the density of SWNTs in a SWNT-FET may be from about 0.5% to about 50%. In some examples, the density of SWNTs in a SWNT-FET may be from about 5% to about 40%. In some examples, the density of SWNTS in a SWNT-FET may be from about 10% to about 25%. In still other examples, the density of SWNTs in a SWNT-FET may be at least 1%, 5%, 10%, 11%, 12%, 13%, 14%, 15%, 16%, 17%, 18%, 19%, 20%, 21%, 22%, 23%, 24%, 25%, 26%, 27%, 28%, 29%, 30%, 32%, 34%, 36%, 38%, 40%, 42%, 44%, 46%, 48%, or 50%.

A SWNT-FET may be fabricated using a number of strategies. In an exemplary strategy, a single SWNT-FET may be fabricated by first coating a conductive substrate with an insulator material. The insulator material may be deposited by a variety of methods that include, for example, thermal oxidation, low pressure chemical vapor deposition (LPCVD), and plasma enhanced chemical vapor deposition (PECVD). The conductive substrate may be made, for example, of silicon (Si), silicon carbide, or other conductive material, whereas the insulator material may be, for example, silicon oxide (e.g., SiO₂), hafnium oxide (e.g., HfO₂), aluminum oxide (e.g., Al₂O₃), other oxides, or other insulator materials.

Next, a layer of catalyst, necessary for SWNT growth, may be deposited onto the coated substrate. The catalyst may be a number of materials which include, for example, for example, be iron(III) nitrate (Fe(NO₃)₃). A layer of SWNTs is then grown, for example, by CVD methods, such that the layer is uniform across the substrate and, in some cases, approximately 1 nm in thickness. A 1-nm thickness may, for example, represent a thickness of about a single SWNT.

Photolithography may then used to define source and drain electrodes on the surface of the formed SWNTs. First, a layer of polydimethylglutarimide (PMGI), which may be approximately 30 nm to 100 nm in thickness is spin coated onto the substrate. In spin coating, an excess amount of material may be deposited to a substrate after which the substrate is spun at high speed in order to spread the material across the substrate by centrifugal force.

Next, a layer of photoresist material may be spin coated on top of the PMGI layer (to form a PMGI/photoresist bilayer) and subsequently exposed to ultraviolet (UV) light through a photomask to pattern the source and drain electrodes. A photomask may be an opaque plate with holes removed such that light may shine through the plate in a defined pattern, determined by the pattern of holes in the plate. The pattern of holes may be used to pattern the PMGI/photoresist bilayer. The photoresist material may be, for example, a positive tone photoresist, a negative tone photoresist, a deep UV photoresist, UV6, or S1813. The UV exposed photoresist may then be developed away, at patterned locations, in a solution of tetramethylammonium hydroxide (TMAH). Exposed PGMI may then be isotropically etched away in the presence of TMAH to complete patterning of the source and drain electrodes.

Next, source and drain metals (e.g., gold, silver, aluminum, chromium, titanium, copper, tantalum, rhodium, cobalt, tungsten, platinum, palladium, or combinations thereof) may be evaporated, sputtered, or electroplated into the patterns. Excess metal and remaining photoresist materials may then be removed in a solvent solution that may comprise, for example, acetone and N-Methyl-2-pyrrolidone (NMP). Remaining PMGI is then removed using a TMAH solution.

Next, another PMGI/photoresist bilayer may be deposited onto the surface of the substrate. The bilayer may be photolithographically patterned as before to protect regions of SWNTs positioned between and around each set of source and drain electrodes. Non-protected regions of SWNTs may then be etched away using an oxygen plasma. The protective PMGI/photoresist bilayer may then be removed in the presence of TMAH, as described above, to produce a SWAT-FET.

To prevent the sticking of photoresist underlayers (e.g., PMGI or other polymers) to the SWNTs and, thus, achieve ultraclean SWNTs in a SWNT-FET, photoresist underlayers may be exposed to ultraviolet light (e.g., a UV flood) after underlayer deposition. UV exposure can make underlayer removal easier during appropriate steps of SWNT-FET fabrication, including those described herein. The number of times UV treatment is completed may depend, for example, on the number of underlayer deposition steps in a SWNT-FET fabrication process. For example, the number of times a UV underlayer treatment is completed during SWNT-FET fabrication may be at least about 1, 2, 3, 4, 5, 6, 7, 8, 9, 10, 11, 12, 13, 14, 15, 16, 17, 18, 19, or 20. In some examples, four UV underlayer treatment steps are completed during SWNT-FET fabrication.

Light of any ultraviolet wavelength (e.g., 10 nm-400 nm) may be used. In some cases, the wavelength of ultraviolet light used is about or at least about 10, 50, 100, 150, 200, 205, 210, 215, 220, 225, 230, 231, 232, 233, 234, 235, 236, 237, 238, 239, 240, 241, 242, 243, 244, 245, 246, 247, 248, 249, 250, 251, 252, 253, 254, 255, 256, 257, 258, 259, 260, 261, 262, 263, 264, 265, 266, 267, 268, 269, 270, 271, 272, 273, 274, 275, 276, 277, 278, 279, 280, 285, 290, 295, 300, 305, 310, 315, 320, 325, 330, 335, 340, 345, 350, 355, 360, 365, 370, 375, 380, 385, 390, 395, or 400 nm. In some cases, the wavelength of ultraviolet used is about 254 nm.

Moreover, the exposure time of an underlayer to UV light may also vary. For example, the exposure time may be about or at least about 0.5, 1, 1.5, 2.0, 2.5, 3.0, 3.5, 4.0, 4.5, 5.0, 5.5, 6.0, 6.5, 7.0, 7.5, 8.0, 8.5, 9.0, 9.5, 10, 11, 12, 13, 14, 15, 16, 17, 18, 19, 20, 25, 30, 35, 40, 45, 50, 55, 60, 65, 70, 75, 80, 85, or 90 min. In some cases the exposure time is about 5 min.

Functionalization of SWNT sensing elements may be achieved with appropriate strategies, including those described herein, after the assembly of SWNT-FET. For example, to functionalize an SWNT-FET with ssDNA, a drop comprising ssDNA may be incubated, at high relative humidity (to prevent drop evaporation), with the SWNT-FET such that the ssDNA self-assembles with the SWNT sensing element of the SWNT-FET via pi-pi stacking interactions with the SWNT sidewall. After incubation for the desired amount of time, residual liquid may be removed with flowing clean nitrogen or other inert gas.

The surface on which SWNTs are grown in a SWNT-FET may impact the amount of amorphous carbon that is generated during SWNT growth. In some cases, a thermal oxide growth surface may help minimize the amount of amorphous carbon that is generated. An example of a thermal oxide is thermally grown silicon dioxide.

In some cases, amorphous carbon may be desirable. In such cases, a tetraethyl orthosilicate (TEOS) growth surface may be employed. TEOS may promote the growth of amorphous carbon during SWNT growth.

A variety of methods may be utilized to grow SWNTs in a SWNT-FET, including those described herein. In one example, a process may be used to minimize the growth of amorphous carbon. In such a process, a thermal oxide layer may be deposited onto a highly doped p-type (p++) silicon layer. A catalyst-forming material may then spin-coated onto the thermal oxide surface, to prepare the silicon-thermal oxide substrate for catalyst formation. In some cases, the catalyst forming material is iron (III) nitrate (Fe(NO₃)₃). In some cases, the catalyst forming material is dissolved in a solvent, such that a solution of catalyst forming material is formed. In one example, an Fe(NO₃)₃ is dissolved in at least about 99.9%, 99.99%, 99.999%, or 99.9999% purity, HPLC-grade isopropyl alcohol (IPA), at an example concentration of 25 mg/L.

Next, the substrate may be heated in air to oxidize the catalyst forming material. In some examples, oxidation of a catalyst forming material occurs by heating at least about 300° C., at least about 350° C., at least about 400° C., at least about 450° C., at least about 500° C., at least about 550° C., at least about 600° C., at least about 650° C., or at least about 700° C. The heating time may vary depending on the particular catalyst-forming material employed. In some cases, the heating time is at least about 30 min, at least about 45 min, at least about 1 hour, at least about 1.25 hours, at least about 1.50 hours, at least about 1.75 hours, at least about 2 hours, at least about 3 hours, at least about 4 hours, or at least about 5 hours.

Oxidation of a catalyst forming material may solidify materials in a solution, such that particulate matter (e.g., particles) is formed. In the case of an Fe(NO₃)₃ solution, oxidation of the Fe(NO₃)₃ may produce iron (II) oxide (Fe₂O₃) particles of well-defined size. The size of such particles may, at least in part, govern the diameter of SWNTs that are eventually formed. In some cases, the ratio of the diameter of SWNTs generated to the diameter of the particle size may vary. In some cases, the ratio of the diameter of SWNTs generated to the diameter of the particle size may be at least about 0.5, 0.6, 0.7, 0.8, 0.9, 1.0, 1.1, 1.2, 1.3, 1.4, 1.5, 1.6, 1.7, 1.8, 1.9, or 2.0.

Following oxidation, the oxidized catalyst-forming materials may be treated in a reduction step to produce catalyst material. For example, where iron Fe₂O₃ particles are formed, reduction of the Fe₂O₃ produces elemental iron (Fe). In some cases, reduction can be achieved in an atmosphere or one or more gaseous materials (e.g., argon (Ar₂), hydrogen (H₂), acid vapor or forming gas).

In some examples, the atmosphere is a mixture comprising both Ar₂ and H₂. In some cases, an atmosphere comprising both Ar₂ and H₂ may be an acid vapor or forming gas. The concentration ratio of Ar₂ to H₂ may vary depending, for example, upon the exposure time for reduction, the amount of material to be reduced and/or the temperature for reduction. For example, the concentration or partial pressure ratio of Ar₂ to H₂ may be from about 1:1 to 100:1 (Ar:H₂), or 1:1 to 50:1. Reduction may require heating, where, in some cases temperature ramping is used. In some examples, reduction temperature is ramped to a final temperature of at least about 700° C., 750° C., 800° C., 850° C., 900° C., 950° C., 1000° C., 1050° C., or 1100° C. At the conclusion of ramping, reduction may also require dwelling of the substrate at the final temperature for a period of time. Dwelling times may vary depending on, for example, the particular materials utilized. In some cases, the dwelling time is at least about 15 min, 30 min, 45 min, 1 hour, 1.25 hours, 1.50 hours, 1.75 hours, 2.0 hours, 2.25 hours, 2.50 hours, 2.75 hours, 3.0 hours, 3.25 hours, 3.50 hours, 3.75 hours, 4.0 hours, 4.25 hours, 4.50 hours, 4.75 hours, 5.0 hours, 5.25 hours, 5.50 hours, 5.75 hours, 6.00 hours, 6.25 hours, 6.50 hours, 6.75 hours, or 7.0 hours.

Following generation of catalyst material, SWNT growth can commence. SWNT growth may commence by introducing a stream of gas comprising a carbonaceous species. In some cases, the stream of gas also comprises other materials that may serve as carriers. In one example, a stream of gas is a mixture of Ar₂, H₂, and methane (CH₄). The flow rate ratio of materials in the stream of gas may be important in avoiding the production of amorphous carbon. In one example, the flow rate ratio of H₂:Ar₂:CH₄ is 1:2:8. In some examples, increased flow of inert materials (e.g., materials not comprising carbon) may also reduce the formation of amorphous carbon.

SWNT growth may require elevated temperatures, and such temperatures may vary. In some examples, the growth temperature may be at least about 700° C., 750° C., 800° C., 850° C., 900° C., 950° C., 1000° C., 1050° C., or 1100° C. Growth times may also vary and can, for example, play a role in the density of SWNTs that are obtained. In some examples, the growth time may be at least about 0.5 minutes (“min”), 1.0 min, 1.5 min, 2.0 min, 2.5 min, 3.0 min, 3.5 min, 4.0 min, 4.5 min, 5.0 min, 5.5 min, 6.0 min, 6.5 min, 7.0 min, 7.5 min, 8.0 min, 8.5 min, 9.0 min, 9.5 min, 10.0 min, 11.0 min, 12.0 min, 13.0 min, 14.0 min, 15.0 min, 16.0 min, 17.0 min, 18.0 min, 19.0 min, or 20.0 min, 25 min, 30 min, 35 min 40 min, 45 min, 50 min, 55 min, 60 min, 65 min, 70 min, 75 min, 80 min, 85 min, 90 min, 95 min, 100 min, 105 min, 110 min, 115 min, or 120 min.

The quality of SWNTs that are generated can be assessed with a number of tools, with non-limiting examples that include surface density (as described elsewhere herein), surface resistance (e.g., resistance measured via two-point contact measurements), and Raman spectroscopy.

In cases where surface resistance is measured, a surface resistance of at least about 100 Ohms (“Ω”), 500 Ω, 1 k Ω, 5 k Ω, 10 k Ω, 50 k Ω, 100 k Ω, 500 k 1M Ω, 5 M Ω, 10 M Ω, 50 M Ω, 100 M Ω, or 500 M Ω may be employed.

Where Raman spectroscopy is used, SWNT quality can be assessed with a G/D ratio. G is the intensity of a Raman peak corresponding to graphitic carbon, and D is the intensity of a Raman peak corresponding to non-graphitic carbon. In some cases, a higher G/D ratios may be desired. For examples, the G/D ratio may be at least about 3:1, 3.5:1, 4:1, 4.5:1, 5:1, 5.5:1, 6:1, 6.5:1, 7:1, 7.5:1, 8.0:1, 8.5:1, 9.0:1, 9.5:1, 10:1, 10.5:1, 11.0:1, 11.5:1, 12.0:1, 12.5:1, 13.0:1, 14.0:1, 15.0:1, 20:1, 30:1, 40:1, 50:1, 100:1, 1000:1, 10000:1, 100000:1, 1000000:1, or up to infinity.

In some example, a SWNT for use in sensing has an on-state resistance less than about 10 MΩ, 5 MΩ, 4 MΩ, 3 MΩ, 2 MΩ, 1 MΩ, 500 kΩ, 400 kΩ, 300 kΩ, 200 kΩ, 100 kΩ, 75 kΩ, 50 kΩ, 25 kΩ, 10 kΩ, 5 kΩ, or, 1 kΩ. In some situations, the on-state resistance of a SWNT is between about 100 kΩ and 500 kΩ, or 200 kΩ and 300 kΩ.

Metallic SWNTs may impede the generation of an acceptable signal. In such cases, it may be desirable to thermally reduce the concentration of, if not eliminate, such metallic SWNTs. Metallic SWNTs may be eliminated, for example, by electrothermal breakdown. In some cases, electrothermal breakdown of metallic SWNTs may be achieved with the application of a source-drain bias pulse to a population of SWNTs. For example, the source-drain bias pulse may be at least about 0.5 volts (“V”), 1V, 5V, 10V, 15V, 20V, 25V, 30V, 35V, 40V, 45V, 50V, 55V, 60V, 65V, 70V, 75V, 80V, 85V, 90V, 95V, 100V, 110V, 120V, 130V, 140V or 150V. Moreover, the pulse time may be, for example, at least about 0.01 seconds (“s”), 0.1 s, 0.5 s, 1 s, 2 s, 3 s, 4 s, 5 s, 6 s, 7 s, 8 s, 9 s, 10 s, 15 s, 20 s, 25 s, 30 s, 35 s, 40 s, 45 s, 50 s, 55 s, 60 s, 65 s, 70 s, or 75 s.

Sensors of the present disclosure can include catalytic material that increases the sensitivity of the sensors to certain analytes (e.g., acetone and NO). For example, a sensor may be more sensitive to NO₂ than NO. A catalyst can be provided for converting NO to NO₂, which can enable the sensor to detect NO. The NO can be included in a fluid that is brought in contact with the sensor during sensing.

In some examples, a catalyst comprises chromium. In an example, the catalyst is CrOₓ, where ‘x’ is a number greater than zero (e.g., CrO₃). The catalyst can be formed between a source electrode and a drain electrode of a sensor. The catalyst can be disposed adjacent or in proximity to a sensing element (e.g., SWNT) of the sensor, such as between SWNT's or below a SWNT. In such a case, a sensor system can include a reference electrode that does not include the catalyst. The reference electrode can include a sensing element.

There are various approaches for providing the catalyst. Such approaches include vapor phase deposition, such as, for example, physical vapor deposition (e.g., sputter deposition).

The sensitivity of sensors of the present disclosure may be enhanced upon the present of water. In some examples, exposure of a sensor to water enhances the detection sensitivity of a sensor by a factor of at least about 1.1, 1.2, 1.3, 1.4, 1.5, 1.6, 1.7, 1.8, 1.9, 2, 3, 4, 5, 6, 7, 8, 9 or 10 for a given analyte. The sensitivity of a sensor may be improved by exposing the sensor to a plasma or UV/ozone.

### Sensor Arrays

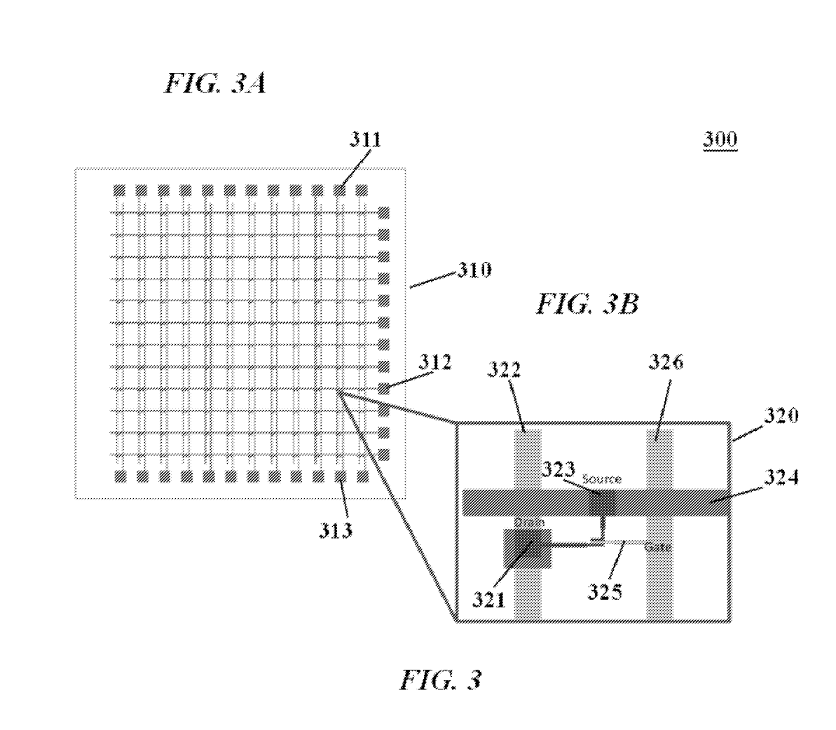

The chemical sensors of a device may be arranged in an array of one or more sensors. An example array 300 comprising multiple SWNT-FET sensors is shown in FIG. 3. An array may include a plurality of individual sensors. An individual sensor may include one or more sensing elements, such as, for example, carbon nanotubes. An individual sensor of the array may be individually addressable. FIG. 3A shows a macroscale view 310 of the example array 300, which is arranged as a square cross-bar array with a 250 μm pitch. FIG. 3B shows an exploded view 320 of an individual SWNT-FET sensor of the example array 300. In FIG. 3B, a SWNT-FET sensor is arranged at each intersection of three cross-bars of the device. Each electrode (e.g., drain, source, and gate) of the SWNT-FET is placed in contact with one of the three intersecting cross-bars. In FIG. 3B, drain electrode 321 is in contact with cross-bar 322, source electrode 323 is in contact with cross-bar 324, and gate electrode 325 is in contact with cross-bar 326. Each cross bar is used to construct multiple SWNT-FET sensors, but generally is only in contact with a common type of electrode. For example, cross-bar 322 is only in contact with drain electrodes, cross-bar 326 is only in contact with gate electrodes, and cross-bar 324 is only in contact with source electrodes. Moreover, each cross bar 322, 324, and 326, is in contact with an electrical contact 311, 312, and 313, respectively, such that electrical energy may be used to supply a voltage across a given set of electrodes. Example array 300 may be first fabricated prior to SWNT growth via metal-catalyzed CVD and/or functionalization with a binding agent to minimize the role of each species in array assembly. Also, the cross-bar design and pitch of example 300 generally render it compatible with standard packaging.

Devices comprise various array configurations and, thus, example array 300 shown in FIG. 3 is non-limiting. Array configurations may vary with respect to a number of aspects with non-limiting examples that include array construction type (e.g., a cross-bar array), the one-, two-, and three-dimensional structures of an array, sensor construction type (e.g., a SWNT-FET), number of arrays, number of sensors that are included on an individual array, the density of sensors on an array, number of a particular sensors included on an individual array, number of different sensors included on an array, addressability of sensors of an array, the dimensions of an array, and the volume of an array.

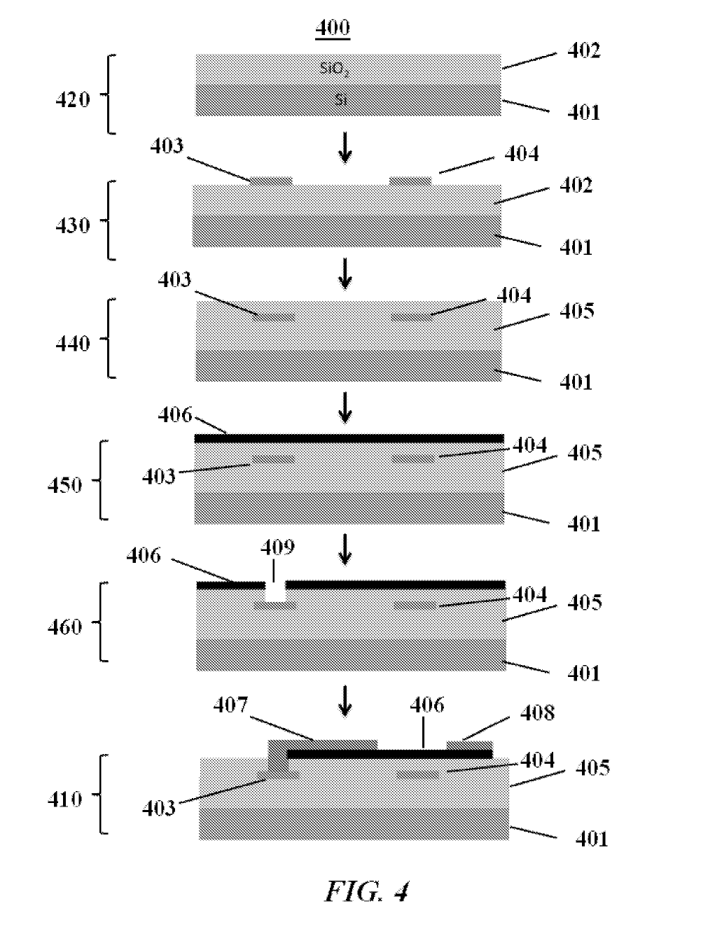

An example method 400 that can be used to fabricate an example SWNT-FET sensor (or sensing device) 410 to be used in a cross-bar array is shown in FIG. 4. First, a device stack 420 may be formed by depositing an insulating (or insulator) layer 402 onto the surface of a substrate 401. The substrate 401 may be conductive or semiconducting. In an example, the substrate 401 includes silicon, silicon carbide, or other conductive or semiconducting material. Insulator layer 402, for example, may be made of SiO₂, another oxide, or another insulator. Insulator layer 402 may be deposited onto the substrate 401 by a variety of methods, such as, for example, thermal oxidation, low pressure chemical vapor deposition (LPCVD), or plasma enhanced chemical vapor deposition (PECVD).

Device layers may be formed with the aid of various deposition techniques. In some embodiments, device layers are formed with the aid of chemical vapor deposition (CVD), atomic layer deposition (ALD), plasma enhanced CVD (PECVD), plasma enhanced ALD (PEALD), metal organic CVD (MOCVD), hot wire CVD (HWCVD), initiated CVD (iCVD), modified CVD (MCVD), vapor axial deposition (VAD), outside vapor deposition (OVD) and physical vapor deposition (e.g., sputter deposition, evaporative deposition). Such deposition techniques can employ vapor phase deposition systems, including vacuum chambers and pumping system that are configured to directed fluid flow into and out of vacuum chambers.

Next, a layer of conductive material may be deposited on the insulator layer 402. This layer may be deposited by, for example, sputtering. This layer may be made of, for example, a metal (e.g., gold, silver, aluminum, chromium, titanium, copper, tantalum, rhodium, cobalt, tungsten, platinum, palladium, or combinations thereof), poly crystalline silicon, crystalline silicon, or combinations thereof. A layer of photoresist may then be spin coated onto the layer of conductive material. The photoresist layer may then be patterned via a source of photomasked ultraviolet (UV) light in order to define traces which include gate electrode 404, a source electrode 403, and a drain electrode (not shown). After patterning, the pattern may then be etched into the conductive material layer using, for example, wet or dry etch techniques. The remaining photoresist material may then be removed in a solvent solution that may include, for example, acetone and NMP, to provide structure 430.

The patterned gate electrode 404, source electrode 403, and drain electrode may then be buried in an insulator layer 405 to provide structure 440. The insulator layer 405 may be of the same material(s) of which insulator layer 402 is made, may be made a different material, or may be made of both the same material(s) of which insulator layer 402 is made and other materials. Such materials may be any of the exemplary insulator material described herein and such materials may be deposited by any exemplary insulator deposition method described herein.

Next, a layer of catalyst, necessary for SWNT growth, may be deposited onto the surface of structure 440. The catalyst may be a number of materials which include, for example, iron(III) nitrate (Fe(NO₃)₃), nickel, molybdenum oxide, silver (e.g., silver nanoparticles), and gold (e.g., gold nanoparticles). A layer of SWNTs 406 may then be grown to form structure 450, for example, by CVD methods, such that the layer 406 is uniform across the substrate and, in some cases, approximately 1 nm in thickness. A 1-nm thickness may, for example, represent a thickness of about a single SWNT.

Next, a PMGI/photoresist bilayer may be deposited onto the surface of structure 450 and may be used to pattern vias 409 over the source 403 and drain electrodes. CNTs located within the pattern may then be etched using an oxygen plasma. The exposed part of insulator layer 405 that results from CNT etching may then be etched by, for example, wet or dry etching techniques, down to both the source 403 and drain electrodes to give structure 460. Remaining photoresist and PMGI may be removed by solvents and TMAH, respectively, as described above.

Next, a PMGI/photoresist bilayer may be deposited onto the structure 460 in order to form vias over the source 403 and drain electrodes. This may be performed in a manner similar to that described above. These vias may be filled with materials to create electrical contacts 407 and 408 for source 403 and drain electrodes, respectively. Materials may be, for example, metals (e.g., gold, silver, aluminum, chromium, titanium, copper, tantalum, rhodium, cobalt, tungsten, platinum, palladium, or combinations thereof) and may be evaporated, sputtered, or electroplated into the vias. Excess metal and remaining photoresist materials may then be removed in a solvent solution that may comprise, for example, acetone and N-Methyl-2-pyrrolidone (NMP). Remaining PMGI is then removed using a TMAH solution.

Next, another PMGI/photoresist bilayer may be deposited onto the surface of the substrate. The bilayer may be photolithographically patterned as before to protect regions of SWNTs positioned between and around each set of source and drain electrodes. Non-protected regions of SWNTs may then be etched away using an oxygen plasma. The protective PMGI/photoresist bilayer may then be removed in the presence of TMAH, as described above, to produce a completed SWNT-FET 410 sensor for use in a cross-bar array. Functionalization of SWNT sensing elements with binding agents may be achieved using any of the exemplary methods described herein.

Devices may comprise sensor arrays with varied numbers of individual sensors. For example, an array may comprise from about 1 individual sensor to 1,000,000, 100,000, or 10,000 individual sensors. In other examples, an array may comprise from about 1 individual sensor to 2000 individual sensors. In still other examples, an array may comprise from about 1 individual sensor to 1024 individual sensors. In some examples, a sensor may comprise about 1, 2, 4, 16, 25, 36, 49, 64, 81, 100, 121, 144, 169, 196, 225, 256, 289, 324, 361, 400, 441, 484, 529, 576, 625, 676, 729, 784, 841, 900, 961, 1024, 1089, 1156, or 1225 individual sensors.

In some examples, an array may comprise at most about 1 individual sensor to 10000 individual sensors. In other examples, an array may comprise at most about 1 individual sensor to 2000 individual sensors. In still other examples, an array may comprise at most about 1 individual sensor to 1024 individual sensors. In some examples, a sensor may comprise from at most about 1, 2, 4, 16, 25, 36, 49, 64, 81, 100, 121, 144, 169, 196, 225, 256, 289, 324, 361, 400, 441, 484, 529, 576, 625, 676, 729, 784, 841, 900, 961, 1024, 1089, 1156, or 1225 individual sensors.

In some examples, an array may comprise at least about 1 individual sensor to 10000 individual sensors. In other examples, an array may comprise at least about 1 individual sensor to 2000 individual sensors. In still other examples, an array may comprise at least about 1 individual sensor to 1024 individual sensors. In some examples, a sensor may comprise from at least about 1, 2, 4, 16, 25, 36, 49, 64, 81, 100, 121, 144, 169, 196, 225, 256, 289, 324, 361, 400, 441, 484, 529, 576, 625, 676, 729, 784, 841, 900, 961, 1024, 1089, 1156, or 1225 individual sensors.

Devices may comprise sensor arrays with varied densities of individual sensors. For example, a sensor array may comprise from about 1 sensor/mm² to 100 sensors/mm². In other examples, a sensor array may comprise from about 1 sensor/mm² to 50 sensors/mm². In still other examples, a sensor array may comprise from about 1 sensor/mm² to 20 sensors/mm². In some examples, a sensor array may comprise about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 65, 70, 75, 80, 85, 90, 95, or 100 sensors/mm².

In some examples, a sensor array may comprise at most about 1 sensor/mm² to 100 sensors/mm². In other examples, a sensor array may comprise at most about 1 sensor/mm² to 50 sensors/mm². In still other examples, a sensor array may comprise at most about 1 sensor/mm² to 20 sensors/mm². In some examples, a sensor array may comprise at most about 1, 2, 3, 4, 5, 6, 7, 8, 9, 10, 11, 112, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 65, 70, 75, 80, 85, 90, 95, or 100 sensors/mm².

In some examples, a sensor array may comprise at least about 1 sensor/mm² to 100 sensors/mm². In other examples, a sensor array may comprise at least about 1 sensor/mm² to 50 sensors/mm². In still other examples, a sensor array may comprise at least about 1 sensor/mm² to 20 sensors/mm². In some examples, a sensor array may comprise at least about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 65, 70, 75, 80, 85, 90, 95, or 100 sensors/mm².

Devices may comprise sensor arrays of that include differing individual sensors. Indeed, sensor variability generally gives a device the capability of sensing a wide variety of analytes. A type of sensor of an array may, for example, be exemplified by the macrostructure of the sensor. An example macrostructure may be a sensor that is arranged as a SWNT-FET. Moreover, a type of sensor of an array may be exemplified by variations within a particular type of macrostructure. In the case of an SWNT-FET sensor, for example, arrays may comprise SWNT-FET individual sensors whose SWNT sensing elements are functionalized with varied types of binding agents, wherein each type of binding agent may also vary in its configuration. In one example, a device may comprise an array of SWNT-FET sensors that comprise ssDNA-functionalized SWNT sensing elements. In some cases, ssDNA binding agents of the SWNT sensing elements in each individual sensor can be of varied nucleotide length, varied base compositions, and/or varied sequencing of component nucleotides all giving rise to differing types of SWNT-FET sensors.

Devices may comprise sensor arrays that comprise varied numbers of different sensor types. For example, a sensor array may comprise from about 1 type of sensor to 1000 different types of sensors. In other examples, a sensor array may comprise from about 1 type of sensor to 100 different types of sensors. In still other examples, a sensor array may comprise from about 1 type of sensor to 20 different types of sensors. In some examples, a sensor may comprise about 1, 2, 4, 16, 25, 36, 49, 64, 81, 100, 121, 144, 169, 196, 225, 256, 289, 324, 361, 400, 441, 484, 529, 576, 625, 676, 729, 784, 841, 900, 961, 1024, 1089, 1156, or 1225 different types of sensors.

In some examples, a sensor array may comprise at least about 1 type of sensor to 1000 different types of sensors. In other examples, a sensor array may comprise at least about 1 type of sensor to 100 different types of sensors. In still other examples, a sensor array may comprise at least about 1 type of sensor to 20 different types of sensors. In some examples, a sensor may comprise at least about 1, 2, 4, 16, 25, 36, 49, 64, 81, 100, 121, 144, 169, 196, 225, 256, 289, 324, 361, 400, 441, 484, 529, 576, 625, 676, 729, 784, 841, 900, 961, 1024, 1089, 1156, or 1225 different types of sensors.

In some examples, a sensor array may comprise at most about 1 type of sensor to 1000 different types of sensors. In other examples, a sensor array may comprise at most about 1 type of sensor to 100 different types of sensors. In still other examples, a sensor array may comprise at most about 1 type of sensor to 20 different types of sensors. In some examples, a sensor may comprise at most about 1, 2, 4, 16, 25, 36, 49, 64, 81, 100, 121, 144, 169, 196, 225, 256, 289, 324, 361, 400, 441, 484, 529, 576, 625, 676, 729, 784, 841, 900, 961, 1024, 1089, 1156, or 1225 different types of sensors.

Devices may comprise sensor arrays that comprise varied numbers of a particular individual sensor. Sensor replicates may be desired for a number of purposes, with non-limiting examples that include improved device sensitivity, improved device specificity, improved device accuracy, improved signal-to-noise ratios, or combinations thereof. For example, a sensor array may comprise from about 1 replicate sensor to 1000 replicate sensors. In other examples, a sensor array may comprise from about 1 replicate sensor to 100 replicate sensors. In still other examples, a sensor array may comprise from about 1 replicate sensor to 20 replicate sensors. In some examples, a sensor array may comprise about 1, 2, 3, 4, 5, 6, 7, 8, 9, 10, 11, 12, 13, 14, 15, 16, 17, 18, 19, 20, 21, 22, 23, 24, 25, 25, 26, 28, 29, 30, 31, 32, 33, 34, 35, 36, 37, 38, 39, 40, 45, 50, 55, 60, 65, 70, 75, 80, 85, 90, 95, 100, 200, 300, 400, 500, 600, 700, 800, 900, or 1000 replicate sensors.

In some examples, a sensor array may comprise at least about 1 replicate sensor to 1000 replicate sensors. In other examples, a sensor array may comprise at least about 1 replicate sensor to 100 replicate sensors. In still other examples, a sensor array may comprise at least about 1 replicate sensor to 20 replicate sensors. In some examples, a sensor array may comprise at least about 1, 2, 3, 4, 5, 6, 7, 8, 9, 10, 11, 12, 13, 14, 15, 16, 17, 18, 19, 20, 21, 22, 23, 24, 25, 25, 26, 28, 29, 30, 31, 32, 33, 34, 35, 36, 37, 38, 39, 40, 45, 50, 55, 60, 65, 70, 75, 80, 85, 90, 95, 100, 200, 300, 400, 500, 600, 700, 800, 900, or 1000 replicate sensors.

In some examples, a sensor array may comprise at most about 1 replicate sensor to 1000 replicate sensors. In other examples, a sensor array may comprise at most about 1 replicate sensor to 100 replicate sensors. In still other examples, a sensor array may comprise at most about 1 replicate sensor to 20 replicate sensors. In some examples, a sensor array may comprise at most about 1, 2, 3, 4, 5, 6, 7, 8, 9, 10, 11, 12, 13, 14, 15, 16, 17, 18, 19, 20, 21, 22, 23, 24, 25, 25, 26, 28, 29, 30, 31, 32, 33, 34, 35, 36, 37, 38, 39, 40, 45, 50, 55, 60, 65, 70, 75, 80, 85, 90, 95, 100, 200, 300, 400, 500, 600, 700, 800, 900, or 1000 replicate sensors.

Devices may comprise sensor arrays of varied size(s). Size may vary, for example, with respect to the cross-sectional area and/or volume of the array. For example, the cross-sectional area of a sensor array may be from about 1 mm² to 1000 mm². In other examples, the cross-sectional area of a sensor array may be from about 1 mm² to 100 mm². In still other examples, the cross-sectional area of a sensor array may be from about 1 mm² to 20 mm². In some examples, the cross-sectional area of a sensor array may be about 1, 5, 10, 15, 20, 25, 30, 35, 40, 45, 50, 55, 60, 65, 70, 75, 80, 85, 90, 95, 100, 150, 200, 250, 300, 350, 400, 450, 500, 600, 700, 800, 900, or 1000 mm².

In some examples, the cross-sectional area of a sensor array may be at least about 1 mm² to 1000 mm². In other examples, the cross-sectional area of a sensor array may be at least about 1 mm² to 100 mm². In still other examples, the cross-sectional area of a sensor array may be at least about 1 mm² to 20 mm². In some examples, the cross-sectional area of a sensor array may be at least about 1, 5, 10, 15, 20, 25, 30, 35, 40, 45, 50, 55, 60, 65, 70, 75, 80, 85, 90, 95, 100, 150, 200, 250, 300, 350, 400, 450, 500, 600, 700, 800, 900, or 1000 mm².

In some examples, the cross-sectional area of a sensor array may be at most about 1 mm² to 1000 mm². In other examples, the cross-sectional area of a sensor array may be at most about 1 mm² to 100 mm². In still other examples, the cross-sectional area of a sensor array may be at most about 1 mm² to 20 mm². In some examples, the cross-sectional area of a sensor array may be at most about 1, 5, 10, 15, 20, 25, 30, 35, 40, 45, 50, 55, 60, 65, 70, 75, 80, 85, 90, 95, 100, 150, 200, 250, 300, 350, 400, 450, 500, 600, 700, 800, 900, or 1000 mm².

Devices may comprise sensor arrays of varied volume. For example, the volume of a sensor array may be from about 0.001 mm³ to 1 mm³. In other examples, the volume of a sensor array may be from about 0.01 mm³ to 0.5 mm³. In still other examples, the volume of a sensor array may be from about 0.01 mm³ to 0.2 mm³. In some examples, the volume of a sensor array may be about 0.01, 0.02, 0.03, 0.04, 0.05, 0.06, 0.07, 0.08, 0.09, 0.1, 0.11, 0.12, 0.13, 0.14, 0.15, 0.16, 0.17, 0.18, 0.19, 0.20, 0.21, 0.22, 0.23, 0.24, 0.25, 0.26, 0.27, 0.28, 0.29, 0.3, 0.35, 0.4, 0.45, 0.50, 0.55, 0.60, 0.65, 0.70, 0.75, 0.80, 0.85, 0.90, 0.95, or 1 mm³.

In some examples, the volume of a sensor array may be at least about 0.001 mm³ to 1 mm³. In other examples, the volume of a sensor array may be at least about 0.01 mm³ to 0.5 mm³. In still other examples, the volume of a sensor array may be at least about 0.01 mm³ to 0.2 mm³. In some examples, the volume of a sensor array may be at least about 0.01, 0.02, 0.03, 0.04, 0.05, 0.06, 0.07, 0.08, 0.09, 0.1, 0.11, 0.12, 0.13, 0.14, 0.15, 0.16, 0.17, 0.18, 0.19, 0.20, 0.21, 0.22, 0.23, 0.24, 0.25, 0.26, 0.27, 0.28, 0.29, 0.3, 0.35, 0.4, 0.45, 0.50, 0.55, 0.60, 0.65, 0.70, 0.75, 0.80, 0.85, 0.90, 0.95, or 1 mm³.

In some examples, the volume of a sensor array may be at most about 0.001 mm³ to 1 mm³. In other examples, the volume of a sensor array may be at most about 0.01 mm³ to 0.5 mm³. In still other examples, the volume of a sensor array may be at most about 0.01 mm³ to 0.2 mm³. In some examples, the volume of a sensor array may be at most about 0.01, 0.02, 0.03, 0.04, 0.05, 0.06, 0.07, 0.08, 0.09, 0.1, 0.11, 0.12, 0.13, 0.14, 0.15, 0.16, 0.17, 0.18, 0.19, 0.20, 0.21, 0.22, 0.23, 0.24, 0.25, 0.26, 0.27, 0.28, 0.29, 0.3, 0.35, 0.4, 0.45, 0.50, 0.55, 0.60, 0.65, 0.70, 0.75, 0.80, 0.85, 0.90, 0.95, or 1 mm³.

Devices may comprise sensor arrays, wherein one or more sensors of the array are individually addressable. In general, the response of an individually addressable sensor may be recorded without interference from, or independently of, other sensors of an array and/or device. Individually addressable sensors may, for example, give a device improved capabilities of discriminating between components of an analyzed vapor sample. In another example, individually addressable sensors may also render a device better capable of analyzing higher numbers of components in a vapor sample. Individually addressable sensors may also be useful in designing an array such that a particular sensor or set of sensors corresponds to a single specific analyte, multiple specific analytes, sets of specific analytes, or combinations thereof. Moreover, a device may comprise on-board addressing electronics that are capable of individually addressing the sensors of a device.

### Readout and Controller Devices

Devices may be in communication with one or more readout devices that may generally be capable of measuring sensor responses. Any readout device capable of detecting a sensor response may be used. In some instances, readout devices may be a set of electronics. An electronic readout device, for example, may be capable of detecting conductivity changes in the SWNT sensing elements of SWNT-FET sensors. Moreover, a readout device may be a component of a device or may be separate from a device. Furthermore, a readout device may also be linked to an adapter that can interface with a controller device.

Readout electronics may be coupled to addressing electronics. In some examples, readout and addressing electronics may be arranged together in an application-specific integrated circuit (ASIC). An ASIC may, for example, comprise a number of components that include, for example, analog-to-digital converters, multiplexers, digital-to-analog converters, transimpedence amps, microprocessors (e.g., an field programmable gate array (FPGA)), or combinations thereof. Moreover, an ASIC may be attached to, or included in, a crossbar array, such as the exemplary crossbar array shown in FIG. 4, for example, by advanced wafer-wafer packaging or die-die wire bonding within a single package.

Devices of the disclosure can include a crossbar (or cross-bar) array. The addressing electronics of a device can be on a complementary metal-oxide-semiconductor (CMOS). A device can include a flow cell, or as an alternative, wafer-level packaging can be used in place of, or in addition to, a flow cell. In some cases, a second wafer can be fabricated with depressions that can serve as flow cells for devices provided herein.

A sensor array may be coupled to readout and/or addressing electronics on a single support, such as, for example, a chip or other substrate. Alternatively, a sensor array and its coupled readout and/or addressing electronics may be coupled on separate supports. Moreover, in cases where a device comprises a single sensor, readout and/or addressing electronics may be coupled on a single support with a sensor, or the two may be coupled on separate supports.

Devices and/or readout devices may be in communication with one or more controller devices (also “controller” herein). A controller device may be capable of controlling a readout device and/or device, receiving outputs from a readout device and/or device, and/or interpreting such outputs into information useful to an end user. Such a controller device, for example, may be a device comprising one or more computer processors (also “processors” herein) that may execute its controller functionality with the aid of its one or more processors. A processor, for example, may be an integrated circuit (IC) microprocessor, a complementary metal-oxide-semiconductor (CMOS) device with an attached microprocessor, or a field programmable gate array (FPGA). Non-limiting examples of controller devices, that may include one or more processors, include a desktop computer, a laptop computer, a tablet computer (e.g., Apple® iPad, Samsung® Galaxy Tab), a cell phone, a smart phone (e.g., Apple® iPhone, Android® enabled phone), a personal digital assistant (PDA), a video-game console, a television, a music playback device (e.g., Apple® iPod), a video playback device, a pager, and a calculator. Moreover, a controller device and/or a processor may be a component of a device or may be separate from a device.

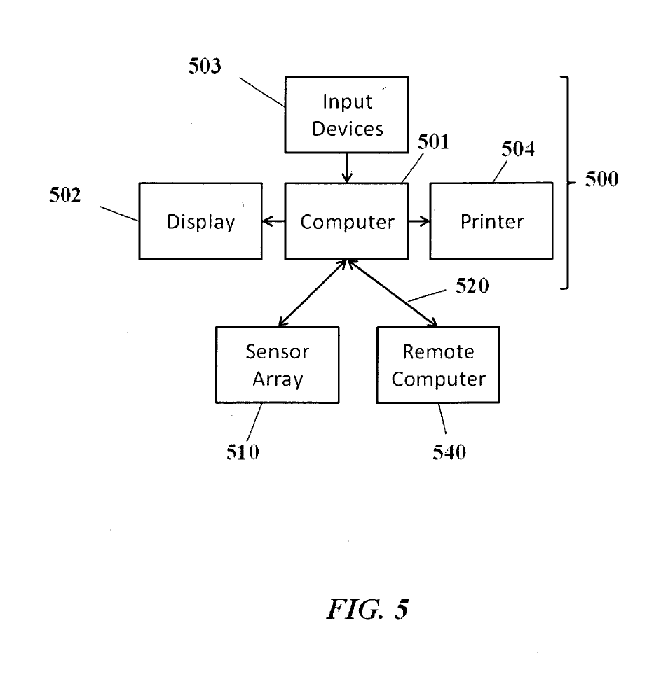

A conceptual schematic for an exemplary control assembly 500 is shown in FIG. 5. A computer 501, which comprises a processor, serves as the central hub for control assembly 500. Computer 501 is in communication with a display 502, one or more optional input devices (e.g., a mouse, keyboard, camera, microphone, etc.) 503, and an optional printer 504. Control assembly 500, via the processor in its computer 501, is in communication with a sensor array 510.

A user may enter desired inputs (e.g., the parameters necessary for a detection of a given analyte or set of analytes) into computer 501 using an input device 503. The inputs are interpreted by computer 501, which communicates such instructions to sensor array 510 for execution.

For example, via on-board circuitry of sensor array 510, such instructions might include, for example, initiating a sensing cycle, the level of electrical current supplied to the array's sensors, the time at which sensor responses are recorded, the duration of time for which sensor responses are recorded. Moreover, during operation of sensor array 510, sensor array 510, perhaps with the aid of readout and/or addressing electronics, may communicate signals back to computer 501 that may include for example, sensor responses. Such signals may be interpreted and used by computer 501 to determine if sensor array 510 requires further instruction.

Signals obtained from sensor array 510 may also be analyzed and interpreted by computer 501. Analysis may be summarized in formats useful to an end user via display 503 and/or printouts generated by printer 504. Instructions or programs used to control sensor array 510; signals obtained from sensor array 510, data acquired from signals obtained from sensor array 510; or data analysis/interpretation may be transmitted to or received from one or more remote computers 530, via a network 520, which, for example, could be the Internet. The network may be accessible wirelessly (e.g., via WiFi connections or cellular connections) or may be accessible by a wired (e.g., RJ-45 Ethernet cables) connection.

In an example, a chemical sensory having an array of sensing elements is electrically coupled to a smart phone. The smart phone can be used to operate the chemical sensor and collect data from the chemical sensor.

A controller device can include or be in communication with a user interface (UI), such as a graphical user interface (GUI), that is configured to enable a user to operate a chemical sensor coupled to the controller device and provide sensing information to the user. A GUI can include textual, graphical and/or audio components. A GUI can be provided on a display of the controller device. The display may include a resistive or capacitive touch screen. The UI can be part of the controller device, or part of an electronic device of the user, such as a mobile (or portable) electronic device.

A controller device can provide an alert or warning to a user based on, for example, one or more analytes detected by a sensor. In some examples, the alert or warning is provided on a UI, such as a GUI of the mobile electronic device of the user.

A controller may be attached to chemical sensor by an electrical connection, such as a wired connection. In some cases, the wired connection may be via a universal serial bus (USB). In some cases, the wired connection may be via a proprietary connection mechanism, unique to the controller and/or the chemical sensor. As an alternative, a controller may be attached to a chemical sensor with the aid of a wireless interface (e.g., WiFi, Bluetooth, radiofrequency (RF), Bluetooth low energy (BILE), infrared (IR) communication, EDGE, GPRS, GSM, EV-DO, satellite, 2G, 3G, 4G, LTE).

Electrical contacts (linked to either a chemical sensor or a controller) that aid in making an electrical connection may be made of a variety of materials. Non-limiting examples of such materials include gold, platinum, palladium, titanium, tungsten, and molybdenum.

A controller may also be attached to a chemical sensor with the aid of a housing or casing also designed to contain and/or protect a controller. In some cases, the housing or casing may comprise a chemical sensor, either permanently fixed to or removable from the housing or casing. In some cases, a chemical sensor may be integrated into a portion of a controller housing or casing such that when the controller is properly placed in the housing or casing, an attachment between the chemical sensor and controller is made. Moreover, a portion of the controller housing or casing that comprises a chemical sensor may be removable such that an attachment between a chemical sensor and a controller is broken when the removable portion is separated from the rest of the housing or casing. Upon reattachment of the removable portion to the rest of the controller housing or casing, the attachment between a chemical sensor and a controller is restored. Such a configuration may permit removal/replacement of the chemical sensor as desired, without completely removing the controller from the housing or casing.

In one example, a controller is a smart phone and may be contained within a protective casing. A removable portion of the protective casing comprises a chemical sensor, such that when the removable portion is properly positioned with the rest of the protective casing, the chemical sensor makes an electrical connection with the smart phone. When the removable portion is separated from the rest of the protective casing, the chemical sensor may be removed or replaced. The removable portion may then be subsequently reassembled with the rest of the protective casing. Upon reassembly, an electrical connection between a chemical sensor (e.g., a replaced sensor) and the controller may be restored.

A controller device and/or chemical sensor may be operatively coupled to a computer server that stores chemical readout information from chemical sensors. The server may include a fingerprint library, as described elsewhere herein.

In an example, a user takes a measurement from a sample using the chemical sensor, and the controller relays a readout from the chemical sensor to a server that is operatively coupled to the controller. The server processes the readout (e.g., compares the readout to a library of known chemical fingerprints) and relays the results to the controller. The results may include an identification of the sample that was measured by the chemical sensor. The results may be presented to the user on a GUI of the controller or an electronic device coupled to the controller.

### Supports and Housings

A device may be arranged on a support, such as, for example, a circuit-board, chip, or other type of substrate. In some cases, a support may comprise a single sensor or may comprise one or more arrays of sensors. Moreover, readout electronics, addressing electronics, processors, or other control assembly components may also be included on a support.

A device may be arranged such that one or more of its components, including a support, are contained within a housing. A housing may, for example, protect sensors of the device from damage, provide for a compact device footprint, combine sensors or sensor arrays with one or more other devices (e.g., one or more readout devices), and/or aid in enclosing a vapor sample to be analyzed. In cases where a housing or casing is used, in whole or part, to enclose a vapor sample, the housing may be open to the ambient environment such that it may accept a vapor sample. Such, openings, for example, may be one or more small vents in the housing or casing that permit the passage of a vapor sample but generally exclude larger objects from accessing the internal compartment of the housing. Additionally, a housing or casing may also enclose one or more fans that are capable of directing a vapor sample into the housing or casing such that it may interact with a contained sensors.

A housing may be formed of a polymeric material, metallic material, or composite material. Metallic materials may include aluminum or stainless steel. In an example, a housing is formed of aluminum.

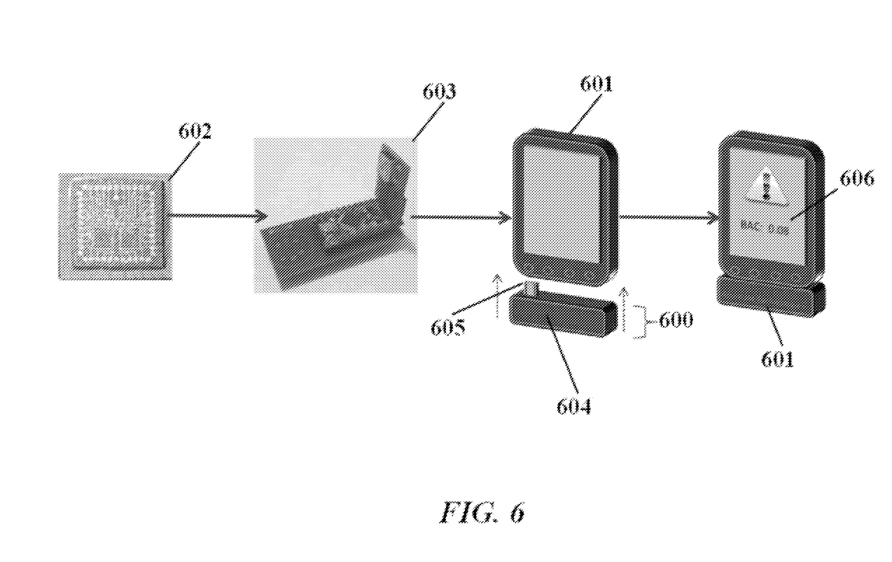

FIG. 6 shows an example device 600 contained within a housing also comprising readout electronics. The device 600 is capable of interfacing with a smart phone 601 (e.g., Apple® iPhone, Android enabled phone). In some cases, the device 600 may fit into a larger housing designed to contain and/or protect smart phone 601. As shown in FIG. 6, a sensor array 602 and electronic readout device 603 are assembled together into a single housing 604 to construct device 600. Housing 604 is capable of receiving a vapor sample such that the vapor sample is adequately brought into contact with its enclosed sensor array 602. Moreover, housing 604 also includes, protruding from its internal compartment that encloses sensor array 602 and electronic readout device 603, a male adaptor 605 that is linked to both sensor array 602 electronic readout device 603 and is capable of interfacing with a female connection port on smart phone 601. Readouts from electronic readout device 603 are communicated to smart phone 601 via male adaptor 605. Moreover, smart phone 601 controls both sensor array 602 and electronic readout device 603 via male adaptor 605. With the aid of its processor, smart phone 601 is capable of analyzing the inputs it receives from electronic readout device 603 and producing a useful signal 606 to the end user, in addition to executing algorithms useful in the operation of sensor array 602 and electronic readout device 603. In one example, housing 604 may be capable of acquiring a subject's breath such that the vapor sample is contacted with sensor array 602, wherein sensor responses are determined with electronic readout device 603 and sent, via male adaptor 605, to smart phone 601 for analysis and interpretation.

### Energy Sources

A sensor may be capable of being powered by various energy sources. Energy sources may include energy storage devices. Examples of energy storage devices include electrostatic energy storage devices (e.g., capacitors), electrochemical energy storage devices (e.g., lithium ion batteries), photovoltaic devices, inductive sources (e.g., wind turbines), nuclear sources, geothermal sources, or grid sources, which may be coupled to fossil-fuel (e.g., natural gas, coal) based sources for power generation. An energy storage device can be a battery. In some instances, a device may be powered via one or more batteries or by one or more traditional plug-in power supplies. In other instances, power to a device may be supplied by another device, such, as for example, an interfaced controller device.

### Device Performance

Devices may vary in their performance characteristics. Non-limiting examples of such performance characteristics include device sensitivity to a given analyte, sensor response rate to a given analyte, the number of analytes a device may detect in a given vapor sample, the number of analytes a device is capable of discriminating in a given vapor sample, the number of repeated sensing events a device is capable of executing without calibration, the speed at which a device may complete a sensing cycle, the capabilities of a device to distinguish between chemically similar species, and the operating requirements of a device with respect to energy consumption. Variations in performance characteristics may be due to a number of factors with non-limiting examples that include the number of sensors included in a device, the type of sensors included in a device, the binding affinity of various sensing elements of a device with a desired analyte, the concentration of a given analyte, the amount of available vapor sample, the number of analytes in a given vapor sample, the amount of a given analyte in a vapor sample, the contact time of a vapor sample with sensors of a device, the response rate of a sensor to a given analyte, or combinations thereof.

Devices may vary in their detection sensitivity to a given analyte. Detection sensitivity of a particular device may depend on, for example, the types of sensors included as part of a device and/or a given analyte to be detected. As a result, a device may have exceptionally low sensitivity for one or more analytes, but may also have relatively higher sensitivities to other analytes. Various devices may generally display such behavior. For example, a device may have a detection sensitivity to a given analyte from about 0.01 parts-per-billion (ppb) to 10 parts-per-million (ppm). In other examples, a device may have a detection sensitivity to a given analyte from about 1 ppb to 1 ppm. In still other examples, a device may have a detection sensitivity from about 1 ppb to 100 ppb. In some examples, a device may have a detection sensitivity to a given analyte of about 0.1, 0.5, 1, 5, 10, 20, 30, 40, 50, 60, 70, 80, 90, 100, 150, 200, 250, 300, 400, 500, 600, 700, 800, or 900 ppb or 1, 5, 10 ppm.

In some examples, a device may have a detection sensitivity to a given analyte of at least about 0.01 parts-per-billion (ppb) to 10 parts-per-million (ppm). In other examples, a device may have a detection sensitivity to a given analyte of at least about 1 ppb to 1 ppm. In still other examples, a device may have a detection sensitivity of at least about 1 ppb to 100 ppb. In some examples, a device may have a detection sensitivity to a given analyte of at least about 0.1, 0.5, 1, 5, 10, 20, 30, 40, 50, 60, 70, 80, 90, 100, 150, 200, 250, 300, 400, 500, 600, 700, 800, or 900 ppb or 1, 5, 10 ppm.

In some examples, a device may have a detection sensitivity to a given analyte of at most about 0.01 parts-per-billion (ppb) to 10 parts-per-million (ppm). In other examples, a device may have a detection sensitivity to a given analyte of at most about 1 ppb to 1 ppm. In still other examples, a device may have a detection sensitivity of at most about 1 ppb to 100 ppb. In some examples, a device may have a detection sensitivity to a given analyte of at most about 0.1, 0.5, 1, 5, 10, 20, 30, 40, 50, 60, 70, 80, 90, 100, 150, 200, 250, 300, 400, 500, 600, 700, 800, or 900 ppb or 1, 5, 10 ppm.

Devices may vary in their response to a given analyte. Responses may be expressed quantitatively as a percent change in a measurable state of a sensor upon its interaction with an analyte. For example, in cases of an SWNT-FET sensor, the response of the sensor may be detected as a change in SWNT sensing element conductivity that is represented by a percentage change in current that flows through the SWNT sensing element upon interaction with an analyte. For example, the response of a sensor may be from about −1000% to +1000%. In other examples, the response of a sensor may be from about −100% to +100%. In still other examples, the response of a sensor may be from about −80% to +80%. In some examples, the response of a sensor may be from about −1000% to +1000%, −100% to +100%, −95% to +95%, −90% to +90%, −85% to +85%, −80% to +80%, −75% to +75%, −70% to +70%, −65% to +65%, −60% to +60%, −55% to +55%, −50% to +50%, −45% to +45%, −40% to +40%, −35% to +35%, −30% to +30%, −25% to +25%, −20% to +20%, −15% to +15%, −10% to +10%, or −5% to +5%.

In some examples, the response of a sensor may be at least about −1000% to +1000%. In other examples, the response of a sensor may be at least about −100% to +100%. In still other examples, the response of a sensor may be at least about −80% to +80%. In some examples, the response of a sensor may be at least about −1000% to +1000%, −100% to +100%, −95% to +95%, −90% to +90%, −85% to +85%, −80% to +80%, −75% to +75%, −70% to +70%, −65% to +65%, −60% to +60%, −55% to +55%, −50% to +50%, −45% to +45%, −40% to +40%, −35% to +35%, −30% to +30%, −25% to +25%, −20% to +20%, −15% to +15%, −10% to +10%, or −5% to +5%.

In some examples, the response of a sensor may be at most about −1000% to +1000%. In other examples, the response of a sensor may be at most about −100% to +100%. In still other examples, the response of a sensor may be at most about −80% to +80%. In some examples, the response of a sensor may be at most about −1000% to +1000%, −100% to +100%, −95% to +95%, −90% to +90%, −85% to +85%, −80% to +80%, −75% to +75%, −70% to +70%, −65% to +65%, −60% to +60%, −55% to +55%, −50% to +50%, −45% to +45%, −40% to +40%, −35% to +35%, −30% to +30%, −25% to +25%, −20% to +20%, −15% to +15%, −10% to +10%, or −5% to +5%.

Devices generally operate with electrical power and may vary in the electrical power required for operation. Power requirements may vary, in part, due to the number of sensors and/or sensor arrays of a device, the need to power additional components such as a fan and/or electronic readout devices, the duration of required operation, the need to minimize electrical noise (which may be important in detecting lower levels of an analyte), the amount of a given analyte to be detected, and combinations thereof. For example, a device may require an electrical power from about 1 mW to 10 W for operation. In other examples, a device may require an electrical power from about 1 mW to 1 W for operation. In still other examples, a device may require an electrical power from about 100 mW to 1 W for operation. In some examples, a device may require an electrical power of about 1, 5, 50, 100, 150, 200, 250, 300, 350, 400, 450, 500, 550, 600, 650, 700, 750, 800, 850, 900, 950 mW or 1 W for operation.

In some examples, a device may require an electrical power of at least about 1 mW to 10 W for operation. In other examples, a device may require an electrical power of at least about 1 mW to 1 W for operation. In still other examples, a device may require an electrical power of at least about 100 mW to 1 W for operation. In some examples, a device may require an electrical power of at least about 1, 5, 50, 100, 150, 200, 250, 300, 350, 400, 450, 500, 550, 600, 650, 700, 750, 800, 850, 900, 950 mW or 1 W for operation.

In some examples, a device may require an electrical power of at most about 1 mW to 10 W for operation. In other examples, a device may require an electrical power of at most about 1 mW to 1 W for operation. In still other examples, a device may require an electrical power of at most about 100 mW to 1 W for operation. In some examples, a device may require an electrical power of at most about 1, 5, 50, 100, 150, 200, 250, 300, 350, 400, 450, 500, 550, 600, 650, 700, 750, 800, 850, 900, 950 mW or 1 W for operation.

Devices may vary in the rate at which they consume electrical energy during operation. For example, a device may consume from about 1 mW of electrical power to about 1 W of electrical power during operation. In other examples, a device may consume from about 100 mW of electrical power to about 1 W of electrical power during operation. In still other examples, a device may consume about 1 mW, 10 mW, 100 mW, 200 mW, 300 mW, 400 mW, 500 mW, 600 mW, 700 mW, 800 mW, 900 mW, or 1 W of electrical power during operation.

In some examples, a device may consume less than about 1 W of electrical power during operation. In other examples, a device may consume less than about 100 mW of electrical power during operation. In still other examples, a device may consume less than about 1 mW, 10 mW, 100 mW, 200 mW, 300 mW, 400 mW, 500 mW, 600 mW, 700 mW, 800 mW, 900 mW, or 1 W of electrical power during operation

Sensor arrays that comprise devices may also vary in the rate at which they consume electrical energy during operation. For example, a sensor array may consume from about 1 nW of electrical power to about 100 mW of electrical power during operation. In other examples, a sensor array may consume from about 100 nW of electrical power to about 10 mW of electrical power during operation. In other examples, a sensor array may consume from about 100 nW of electrical power to about 1 mW of electrical power during operation. In still other examples, a sensor array may consume about 1, 10, 100, 200, 300, 400, 500, 600, 700, 800, 900 nW, or 1, 2, 3, 4, 5, 6, 7, 9, 10, or 100 mW of electrical power during operation.

In some examples, a sensor array may consume less than about 100 mW of electrical power during operation. In other examples, a sensor array may consume less than about 10 mW of electrical power during operation. In other examples, a sensor array may consume less than about 1 mW of electrical power during operation. In still other examples, a sensor array may consume less than about 1, 10, 100, 200, 300, 400, 500, 600, 700, 800, 900 nW, or 1, 2, 3, 4, 5, 6, 7, 9, 10, or 100 mW of electrical power during operation.

Devices may vary in the number of analytes of which they are capable of detecting at a given time. The number of analytes of which a device is capable of detecting at a given time may depend on a number of factors with non-limiting examples that include the number of sensors included as part of a device, the different sensors included as part of a device, or a combination thereof. For example, a device may be capable of detecting from about 1 analyte to 100 analytes at a given time. In other examples, a device may be capable of detecting from about 1 analyte to 50 analytes at a given time. In still other examples, a device may be capable of detecting from about 1 analyte to 10 analytes at a given time. In some examples, a device may be capable of detecting about 1, 2, 3, 4, 5, 6, 7, 8, 9, 10, 11, 12, 13, 14, 15, 16, 17, 18, 19, 20, 30, 40, 50, 60, 70, 80, 90, or 100 analytes at a given time.

In some examples, a device may be capable of detecting at least about 1 analyte to 100 analytes at a given time. In other examples, a device may be capable of detecting at least about 1 analyte to 50 analytes at a given time. In still other examples, a device may be capable of detecting at least about 1 analyte to 10 analytes at a given time. In some examples, a device may be capable of detecting at least about 1, 2, 3, 4, 5, 6, 7, 8, 9, 10, 11, 12, 13, 14, 15, 16, 17, 18, 19, 20, 30, 40, 50, 60, 70, 80, 90, or 100 analytes at a given time.

In some examples, a device may be capable of detecting at most about 1 analyte to 100 analytes at a given time. In other examples, a device may be capable of detecting at most about 1 analyte to 50 analytes at a given time. In still other examples, a device may be capable of detecting at most about 1 analyte to 10 analytes at a given time. In some examples, a device may be capable of detecting at most about 1, 2, 3, 4, 5, 6, 7, 8, 9, 10, 11, 12, 13, 14, 15, 16, 17, 18, 19, 20, 30, 40, 50, 60, 70, 80, 90, or 100 analytes at a given time.

Devices may vary in the number of analytes of which they can discriminate from others in a vapor sample. Many vapor samples supplied to a device may be mixtures that comprise one or more analytes. In some instances, a vapor sample may comprise a large number of analytes and may, thus, require a device with finer analyte discrimination capabilities for proper detection. In some examples, a given sensor may be capable of detecting a number of analytes, yet binding of each analyte results in the same change in sensor state. Such indifference may be minimized, for example, by constructing a device of more varied sensor types that are capable of discriminating between analytes of interest. Moreover, a device may be capable of discriminating between chemically similar species that may differ, for example, by only a few atoms or that may isomers or stereoisomers. In general, however, a devices may be capable of discriminating between two or more analytes. For example, a device may be capable of discriminating from about 1 to 100 analytes in a vapor sample. In other examples, a device may be capable of discriminating from about 1 to 50 analytes in a vapor sample. In still other examples, a device may be capable of discriminating from about 1 to 10 analytes in a vapor sample. In some examples, a device may be capable of discriminating about 1, 2, 3, 4, 5, 6, 7, 8, 9, 10, 11, 12, 13, 14, 15, 16, 17, 18, 19, 20, 30, 40, 50, 60, 70, 80, 90, or 100 analytes in a vapor sample.

In some examples, a device may be capable of discriminating at least about 1 to 100 analytes in a vapor sample. In other examples, a device may be capable of discriminating at least about 1 to 50 analytes in a vapor sample. In still other examples, a device may be capable of discriminating at least about 1 to 10 analytes in a vapor sample. In some examples, a device may be capable of discriminating at least about 1, 2, 3, 4, 5, 6, 7, 8, 9, 10, 11, 12, 13, 14, 15, 16, 17, 18, 19, 20, 30, 40, 50, 60, 70, 80, 90, or 100 analytes in a vapor sample.

In some examples, a device may be capable of discriminating at most about 1 to 100 analytes in a vapor sample. In other examples, a device may be capable of discriminating at most about 1 to 50 analytes in a vapor sample. In still other examples, a device may be capable of discriminating at most about 1 to 10 analytes in a vapor sample. In some examples, a device may be capable of discriminating at most about 1, 2, 3, 4, 5, 6, 7, 8, 9, 10, 11, 12, 13, 14, 15, 16, 17, 18, 19, 20, 30, 40, 50, 60, 70, 80, 90, or 100 analytes in a vapor sample.

Devices may be reusable and may be capable of repeated sensing cycles without calibration or sensor replacement. Reversible binding of an analyte with a binding agent, for example, may aid in sensor regeneration and minimized need for sensor replacement and, thus, subsequent calibration. For example, a device may be capable of being used through about 1-100, 1-1000, or 1-100,000 sensing cycles without calibration or sensor replacement. In other examples, a device may be capable of being used through about 1-50 sensing cycles without calibration or sensor replacement. In some examples, a device may be capable of being used through about 1, 5, 10, 20, 30, 40, 50, 60, 70, 80, 90, 100, 150, 200, 250, 300, 350, 400, 450, 500, 550, 600, 650, 700, 800, 900, 1000, 10,000, or 100,000 sensing cycles without calibration or sensor replacement.

In some examples, a device may be capable of being used through at least about 1-100, 1-1000, or 1-100,000 sensing cycles without calibration or sensor replacement. In other examples, a device may be capable of being used through at least about 1-50 sensing cycles without calibration or sensor replacement. In some examples, a device may be capable of being used through at least about 1, 5, 10, 20, 30, 40, 50, 60, 70, 80, 90, 100, 150, 200, 250, 300, 350, 400, 450, 500, 550, 600, 650, 700, 800, 900, 1000, 10,000, or 100,000 sensing cycles without calibration or sensor replacement.

In some examples, a device may be capable of being used through at most about 1-100, 1-1000, or 1-100,000 sensing cycles without calibration or sensor replacement. In other examples, a device may be capable of being used through at most about 1-50 sensing cycles without calibration or sensor replacement. In some examples, a device may be capable of being used through at most about 1, 5, 10, 20, 30, 40, 50, 60, 70, 80, 90, 100, 150, 200, 250, 300, 350, 400, 450, 500, 550, 600, 650, 700, 800, 900, 1000, 10,000, or 100,000 sensing cycles without calibration or sensor replacement.

Devices may vary in the time required to complete a sensing cycle. Sensing cycle times may vary due to a number of factors with non-limiting examples that include the concentration of analyte(s) being analyzed, the power supplied to the device, the type of sensors of a device, the number of duplicates of an individual sensor type, the desired sensitivity of detection, the number of analytes to be analyzed, and combinations thereof. For example, a device may be capable of performing a sensing cycle in about 0.001 seconds to 60 seconds. In other examples, a device may be capable of performing a sensing cycle in about 0.1 seconds to 10 seconds. In still other examples, a device may be capable of performing a sensing cycle in about 0.1 seconds to 1 second. In some examples a device may be capable of performing a sensing cycle in about 0.01, 0.05, 0.1, 0.25, 0.5, 0.75, 1, 1.5, 2, 2.5, 3, 3.5, 4, 4.5, 5, 5.5, 6, 6.5, 7, 7.5, 8, 8.5, 9, 9.5, 10, 15, 20, 25, 30, 40, 50, or 60 seconds.

In some examples, a device may be capable of performing a sensing cycle in at least about 0.001 seconds to 60 seconds. In other examples, a device may be capable of performing a sensing cycle in at least about 0.1 seconds to 10 seconds. In still other examples, a device may be capable of performing a sensing cycle in at least about 0.1 seconds to 1 second. In some examples a device may be capable of performing a sensing cycle in at least about 0.01, 0.05, 0.1, 0.25, 0.5, 0.75, 1, 1.5, 2, 2.5, 3, 3.5, 4, 4.5, 5, 5.5, 6, 6.5, 7, 7.5, 8, 8.5, 9, 9.5, 10, 15, 20, 25, 30, 40, 50, or 60 seconds.

In some examples, a device may be capable of performing a sensing cycle in at least at most about 0.001 seconds to 60 seconds. In other examples, a device may be capable of performing a sensing cycle in at least at most about 0.1 seconds to 10 seconds. In still other examples, a device may be capable of performing a sensing cycle in at least at most about 0.1 seconds to 1 second. In some examples a device may be capable of performing a sensing cycle in at least at most about 0.01, 0.05, 0.1, 0.25, 0.5, 0.75, 1, 1.5, 2, 2.5, 3, 3.5, 4, 4.5, 5, 5.5, 6, 6.5, 7, 7.5, 8, 8.5, 9, 9.5, 10, 15, 20, 25, 30, 40, 50, or 60 seconds.

Devices may be designed for single-usage and/or may also be disposable. Single-usage devices may be arranged, for example, such that they are powered by one or more batteries, wherein the lifetime of the device is determined by onboard battery life. Such a configuration may also be useful for devices designed for limited-time applications.

Methods for Analysis and/or Detection

The disclosure provides methods that may be utilized to analyze the composition of a sample, such as a vapor mixture, a liquid mixture, a solid-liquid mixture, or a vapor-liquid mixture. The methods disclosed herein broadly include the steps of a) providing a vapor sample to a chemical vapor sensing device; b) using at least one readout device to measure a response from each individual sensor of the chemical vapor sensing device when one or more of the individual sensors is in contact with the vapor sample; and c) using the responses from at least a subset of the individual sensors of the chemical vapor sensing device to identify at least one chemical component of the vapor sample. Variations of these method steps, variations of additional, optional method steps, and varied sequencing of such steps may be exemplified by specific methods of the disclosure and are further described elsewhere herein. Moreover, methods of the disclosure may be executed with any of the devices described above.

A sample that is provided to a chemical vapor sensing device may generally be in the vapor phase. In some cases, a vapor phase sample may be pure such that it comprises a single chemical component. In other cases, a vapor sample may be a mixture of two or more chemical components in the vapor phase. Moreover, a vapor sample may contain one or more solid components mixed with a vapor phase, wherein the solid components are, for example, particulates capable of being transported by the vapor phase. Vapor samples may be obtained from a number of sources with non-limiting examples that include atmospheric sources (e.g., atmospheric air—a mixture of oxygen and nitrogen that is generally included in the Earth's atmosphere), geologic sources (e.g., volcanic vapor emissions), industrial sources (e.g., vapor streams omitted from chemical production/processing facilities), or biological sources (e.g., breath from a living organism, flatulence from a living organism, or other vapor phase emitted from a living organism). In some examples, a vapor sample comprises, in whole or part, human breath. In some examples, a vapor sample comprises atmospheric air mixed with one or more other chemical components.

Varied strategies, both active and passive, may be used to supply a vapor sample to a chemical vapor sensing device in executing a method. For example, in cases where a vapor sample is human breath, a device may be capable of accepting human breath that is exhaled, passively or forcefully, from a subject's mouth. For example, a sensing device may be attached to a cell phone such that breath emitted during a phone conversation passively diffuses to supply a vapor sample to a device. Alternatively, a user of such a device may forcefully blow breath such that it is supplied to the attached sensing device. In other examples, passive diffusion may be used to supply a vapor sample to a device. In still other examples, active transport methods, such as, for example, forced flow via a fan or pump, may be used to supply a vapor sample to a device. Active transport methods may also be used to mix a vapor phase with one or more analytes for detection. A fan, for example, may be used to mix a vapor stream with one or more other vapor streams, liquids, or solid particulates to form a vapor sample and, optionally, also provide the vapor sample to a chemical sensing device. Such a strategy may be used, for example, to capture an analyte from at least one surface of a living organism and provide the resulting vapor sample to a chemical sensing device. Moreover, convective transport methods, such as, for example, a fan, may also be used to volatilize a liquid phase analyte, which may or may not mix with another vapor phase upon volatilization, and, optionally, then supply the vapor product to a chemical vapor sensing device.

### Chemical Fingerprint(s)

Methods may rely on one or more chemical fingerprints to identify one or more components of a vapor sample. In some examples, a chemical fingerprint is generated by exposing a chemical vapor sensing device to a known sample (e.g., NO₂) and measuring readouts (e.g., electronic signature) from the device's sensors. In other examples, fingerprints may be generated for mixtures of known samples having known proportions (e.g., 30% NO₂ and 70% SO₂). The readout may be from one or more individual sensors (e.g., nanotube coupled to electrodes) of the chemical vapor sensing device, or collectively from a plurality of sensors. As such, by exposing the chemical sensor to known samples and mixtures of samples with known proportions, a fingerprint of at least 1, 2, 3, 4, 5, 6, 7, 8, 9, 10, 100, 1000, 10,000, 100,000, or 1,000,000 chemical species and mixtures of chemical species with varying proportions can be obtained.

Moreover, a plurality of sensors that are used to generate a chemical fingerprint for a particular chemical species may comprise, for example, different sensor types, wherein at least one or more of the sensor types respond differently from other sensor types in the set when in contact with the chemical species. The collection of responses from each sensor type generally represents the chemical fingerprint for that species. The response of a particular sensor type that is used to construct a chemical fingerprint may be obtained from a single sensor or may be obtained from a set of replicate sensors of a given sensor type. For example, in such cases where replicate sensors are used, the response of a given sensor type used to construct a chemical fingerprint may be an average of the individual responses of each replicate of a given sensor type.

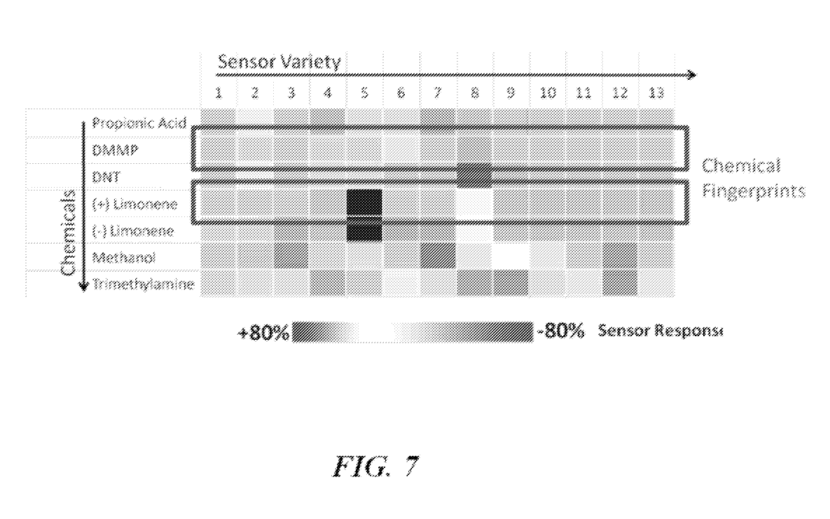

Examples of several chemical fingerprints are tabulated in FIG. 7. In FIG. 7, a chemical vapor sensing device comprising thirteen different types of sensors are exposed to seven separate air samples that each comprise one of the following test chemicals: dimethyl methylphosphonate (DMMP), (+) limonene, (−) limonene ((+) limonene and (−) limonene are stereoisomers of limonene), methanol, and trimethylamine. As shown in FIG. 7, the collection of responses from each sensor type for a given test chemical represents its chemical fingerprint. Each sensor type responds differently to each different test chemical such that the collection of responses from each type of sensor is unique for each test chemical.

Methods may utilize varied numbers of sensor types to generate a chemical fingerprint. For example, a chemical fingerprint may comprise responses from about 1 sensor type to 100 sensor types. In other examples, a chemical fingerprint may comprise responses from about 1 sensor type to 50 sensor types. In still other examples, a chemical fingerprint may comprise responses from about 1 sensor type to 20 sensor types. In some examples, a chemical fingerprint may comprise responses about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 35, 40, 45, 50, 55, 60, 65, 70, 75, 80, 85, 90, 95, or 100 sensor types.

In some examples, a chemical fingerprint may comprise responses at least about 1 sensor type to 100 sensor types. In other examples, a chemical fingerprint may comprise responses at least about 1 sensor type to 50 sensor types. In still other examples, a chemical fingerprint may comprise responses at least about 1 sensor type to 20 sensor types. In some examples, a chemical fingerprint may comprise responses from at least about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 35, 40, 45, 50, 55, 60, 65, 70, 75, 80, 85, 90, 95, or 100 sensor types.

In some examples, a chemical fingerprint may comprise responses at most about 1 sensor type to 100 sensor types. In other examples, a chemical fingerprint may comprise responses at most about 1 sensor type to 50 sensor types. In still other examples, a chemical fingerprint may comprise responses at most about 1 sensor type to 20 sensor types. In some examples, a chemical fingerprint may comprise responses from at most about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 35, 40, 45, 50, 55, 60, 65, 70, 75, 80, 85, 90, 95, or 100 sensor types.

Various chemical fingerprints may be aggregated to form a chemical fingerprint library. A chemical vapor sensing device may be trained such that a chemical fingerprint library is stored in on-board memory, such as, for example, memory comprised in one or more components of a control assembly. Alternatively, a chemical library may be stored on an external device, such as a mobile device (e.g., a cell phone, smart phone, personal display assistant (PDA), etc) or computer (e.g., desktop computer, laptop computer, tablet computer), capable of communicating with a chemical vapor sensing device. Methods generally rely on chemical fingerprint libraries of varied size. For example, a chemical fingerprint library may comprise from about 1 chemical fingerprint to 1,000,000 chemical fingerprints. In other examples, a chemical fingerprint library may comprise from about 1 chemical fingerprint to 10,000 chemical fingerprints. In still other examples, a chemical fingerprint library may comprise from about 1 chemical fingerprint to about 1,000 chemical fingerprints. In still other examples, a chemical fingerprint library may comprise from about 1 chemical fingerprint to about 100 chemical fingerprints. In some examples, a chemical fingerprint library may comprise about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 35, 40, 45, 50, 55, 60, 65, 70, 75, 80, 85, 90, 95, 100, 150, 200, 250, 300, 350, 400, 450, 500, 550, 600, 700, 800, 900, 1000, 10,000, 100,000, or 1,000,000 chemical fingerprints.

In some examples, a chemical fingerprint library may comprise at least about 1 chemical fingerprint to 1,000,000 chemical fingerprints. In other examples, a chemical fingerprint library may comprise at least about 1 chemical fingerprint to 10,000 chemical fingerprints. In still other examples, a chemical fingerprint library may comprise at least about 1 chemical fingerprint to about 1,000 chemical fingerprints. In still other examples, a chemical fingerprint library may comprise from at least about 1 chemical fingerprint to 100 chemical fingerprints. In some examples, a chemical fingerprint library may comprise at least about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 35, 40, 45, 50, 55, 60, 65, 70, 75, 80, 85, 90, 95, 100, 150, 200, 250, 300, 350, 400, 450, 500, 550, 600, 700, 800, 900, 1000, 10,000, 100,000, or 1,000,000 chemical fingerprints.

In some examples, a chemical fingerprint library may comprise at most about 1 chemical fingerprint to 1,000,000 chemical fingerprints. In other examples, a chemical fingerprint library may comprise at most about 1 chemical fingerprint to 10,000 chemical fingerprints. In still other examples, a chemical fingerprint library may comprise at most about 1 chemical fingerprint to about 1,000 chemical fingerprints. In still other examples, a chemical fingerprint library may comprise from at most about 1 chemical fingerprint to 100 chemical fingerprints. In some examples, a chemical fingerprint library may comprise at most about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 35, 40, 45, 50, 55, 60, 65, 70, 75, 80, 85, 90, 95, 100, 150, 200, 250, 300, 350, 400, 450, 500, 550, 600, 700, 800, 900, 1000, 10,000, 100,000, or 1,000,000 chemical fingerprints.

Methods may utilize chemical fingerprint libraries to determine a chemical profile of a vapor sample. In general, a chemical fingerprint library may be used to generate a chemical profile of a given vapor sample by serving as a comparison tool for individual sensor responses generated from a chemical vapor sensing device during analyte sensing. As responses from different types of sensors of a device are recorded after the sensors are contacted with a vapor sample, computational methods with the aid of a computer processor may be used to conduct a fingerprint analysis of the recorded responses. In a fingerprint analysis, the recorded responses from different sensor types may be compared to response patterns of chemical fingerprints contained within a chemical fingerprint library. Matching chemical fingerprints that correspond, in whole or part, to the response patterns recorded from sensors of the device may be identified. Identification of matching chemical fingerprints may then be used to conclude that the species' that correspond to the matching chemical fingerprints are components of the vapor sample analyzed. Moreover, a chemical profile obtained for a given vapor sample may be qualitative such that it describes the presence of one or more components of a vapor sample or may also be quantitative such that it also describes the amounts and/or concentrations of one or more components in the vapor sample.

A chemical fingerprint may be based on one or more sensor readouts of a sensor device having an array of sensors. For example, a chemical fingerprint may be dependent on at least 1, 2, 3, 4, 5, 6, 7, 8, 9, 10, 20, 30, 40, 50, 100, 1000, 10,000, or 100,000 individual sensor readouts. The sensor readouts may be obtained at the same or substantially the same time.

### Applications

Devices and/or methods may be used for a range of applications with non-limiting examples that include determining the freshness of food, identification of spilled chemicals, identification of a biowarfare agent, diagnostics of disease states, determination of explosives, evaluation of the contents of containers or vehicles, and evaluation of air quality (e.g., the level of particulate matter, hazardous materials, and/or other foreign materials that are present in atmospheric air). Chemical profiles obtained from devices and/or methods may be used exclusively or may be combined with other devices and/or methods to reach appropriate conclusions in a given application.

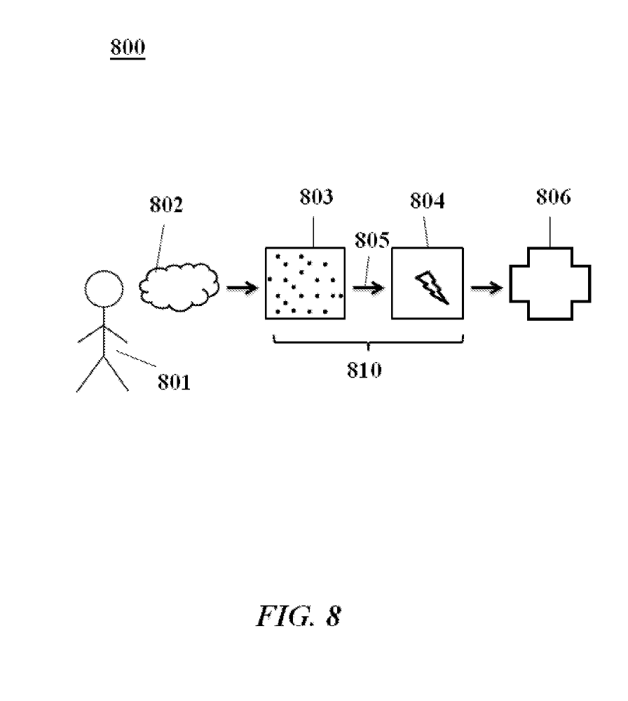

Devices and/or methods for chemical sensing may be useful in disease diagnostics and/or detection. The early detection of many diseases is a function of patient awareness and the availability of convenient screening. Indeed, early detection, diagnosis, and treatment of many disease states are crucially important to positive outcomes. In an exemplary method 800 shown in FIG. 8, a chemical vapor sensing device having an array of sensors may be coupled to a system capable of correlating the presence and/or concentration of one or more analytes in a vapor sample obtained from a subject to a disorder or disease condition. As shown in FIG. 8, subject 801 exhales a breath sample 802. Breath sample 802 may be received by chemical vapor sensor device 803, comprising an array of sensors, and subject to sensing. Chemical vapor sensing device 803 is in communication with computer 804, together comprised in system 810. Computer 804 is capable of correlating the presence and/or concentration of one or more analytes in the breath sample 802 received from subject 801 to one or more disorders or disease conditions. Computer 804 receives sensor signals 805 from chemical vapor sensing device 803 and aids in determining if subject 801 has a disorder or condition. In the case where a disorder or condition is diagnosable from the sensor data analysis by computer 804, computer 804 or a trained professional interpreting an output from computer 804 may make decisions regarding appropriate therapeutic courses of action 806, such as for example drug, surgical, and/or radiation interventions.

Devices and/or methods for chemical sensing may be useful for cancer diagnostics, cancer detection, cancer diagnosis, cancer staging, the evaluation of cancer treatments, the evaluation of cancer progression, or combinations thereof. In the case of many types of cancer, survival rates can reach 98% if detected at early stages. In general, various cancers may be known to be associated with certain biomarker chemicals that may be detected. For example, skin cancer may be associated with dimethyl sulfone or isovaleric acid, such that either chemical may be found at the surfaces of lesions. Sensors of the present disclosure may detect dimethyl sulfone at a concentration of less than or equal to about 100 ppm, 1 ppm, 100 ppb, or 25 ppb. In some examples, a chemical vapor sensing device comprised of a fan may be used for skin cancer diagnostics, wherein the fan captures dimethyl sulfone from the surface of a suspect lesion on a subject's skin and supplies it to a chemical vapor sensing device for analysis. Compact, portable devices may be especially desirable in such an application. The detection of dimethyl sulfone and/or the detection of abnormal levels of dimethyl sulfone may indicate that the lesion is malignant. Continued dimethyl sulfone sensing from a confirmed malignancy may be used to evaluate the progression of a skin cancer and/or its response to treatment modalities.

In another example, breast cancer may be associated with propanol and/or heptanal found in human breath. New indications of propanol and/or heptanal or elevated levels of propanol and/or heptanal in a subject's breath may be used to detect or diagnose breast cancer. Moreover, continued monitoring of propanol and/or heptanal in a diagnosed subject's breath may be used to evaluate the progression of a breast cancer and/or the evaluation of treatment modalities. Sensors of the present disclosure may detect heptanal at a concentration of less than or equal to about 10000 ppm, 1000 ppm, 100 ppm, or 10 ppm, and propanol at a concentration of less than or equal to about 10000 ppm, 9000 ppm, or 8000 ppm. In another example, lung cancer may be detected and/or monitored in analogous fashion to that described above for breast cancer via the detection of chemicals associated with lung cancer from a subject's breath with non-limiting examples that include methylethylketone, propanol, aniline, acetaldehyde, and toluene. Sensors of the present disclosure may detect methylethylketone at a concentration of less than or equal to about 10000 ppm, 1000 ppm, 100 ppm, 10 ppm, or 5 ppm, and aniline at a concentration of less than or equal to about 10000 ppm, 1000 ppm, 100 ppm, 10 ppm, 5 ppm, or 1 ppm.

Additional cancers that may be detected by analyzing human breath or vapors comprising human-derived materials include prostate cancer, cervical cancer, and ovarian cancer.

Devices and/or methods for chemical sensing may be used to detect, diagnose, and/or evaluate the treatment of a pulmonary disorder. A pulmonary disorder may include any ailment of the respiratory system of a living organism, such as, for example, chronic obstructive pulmonary disorder (COPD). A pulmonary disorder may be associated with one or more related biomarkers that may be detected in a subject's breath or other subject-derived vapor stream. For example, COPD may be detected, diagnosed, and/or evaluated through the detection of nitric oxide, nitrogen dioxide, and/or hydrogen peroxide in a subject's breath. Sensors of the present disclosure may detect NO₂ at a concentration of less than or equal to about 100 ppm, 1 ppm, 100 ppb, or 10 ppb.

Devices and/or methods for chemical sensing may be used to detect, diagnose, and/or evaluate the treatment of an infectious disease or disorder. An infectious disease or disorder may, for example, include any ailment resulting from the infection, presence, and growth of pathogenic biological agents (e.g., viruses, bacteria, fungi, protozoa, parasites, prions, etc.) in a host organism. Non-limiting examples of infectious diseases or disorders include tuberculosis, malaria, and sinusitis. An infectious disorder may be associated with one or more related biomarkers that may be detected in a subject's breath or other subject-derived vapor stream. For example, tuberculosis may be detected, diagnosed, and/or evaluated through the detection of phenylacetic acid, nicotinic acid, ammonia, nitric oxide, and/or nitrogen dioxide in a subject's breath. Sensors of the present disclosure may detect ammonia at a concentration of less than or equal to about 100 ppm, 1 ppm, 100 ppb, or 20 ppb, and nitrogen dioxide at a concentration of less than or equal to about 100 ppm, 1 ppm, 100 ppb, or 10 ppb.

Devices and/or methods for chemical sensing may be used to detect, diagnose, and/or evaluate the treatment of a metabolic disorder. A metabolic disorder may, for example, include any ailment resulting abnormal metabolism. Non-limiting examples of infectious diseases include diabetes, keto-acidosis, kidney disease, uremia (e.g., kidney failure), and liver disease. In the case of uremia, uremia may be detected, diagnosed, and/or evaluated through the detection of dimethyl amine and trimethyl amine. Sensors of the present disclosure may detect dimethyl amine at a concentration of less than or equal to about 100 ppm, 1 ppm, 100 ppb, or 20 ppb, and trimethyl amine at a concentration of less than or equal to about 100 ppm, 1 ppm, 500 ppb, or 300 ppb.

For example, a common indicator of diabetes that may be used clinically is blood glucose level. Blood glucose levels, for example, may be linked to the presence and/or levels of acetone, acetophenone, α-Hydroxybutyrate, β-Hydroxybutyrate, acetoacetic acid, or combinations thereof in a subject's breath. Sensors of the present disclosure may detect acetone at a concentration of less than or equal to about 10000 ppm, 5000 ppm, or 4000 ppm. Detection of any one or more of these species and/or quantification of species levels from a subject's breath may be used to assess a subject's blood glucose level, and, thus, via inference, give insight to a subject's overall metabolic state. Moreover, detection of blood glucose levels may also be useful in assessing a subject's propensity to acquire diabetes or monitoring the blood glucose levels of already diabetic subjects. Non-invasive breath sensing methods may be attractive over more traditional glucose meters that generally require skin lacerations to obtain blood samples directly.

Devices and/or methods for chemical sensing may be used to detect, diagnose, and/or evaluate the treatment of Epilepsy. Epilepsy generally refers to any neurological ailment that may be characterized by seizures. Epilepsy may be associated with one or more related biomarkers that may be detected in a subject's breath or other subject-derived vapor stream.

Devices and/or methods for chemical sensing may be used to evaluate a subject's metabolic rate (e.g., the rate at which energy is consumed by a subject per unit time) and/or a subject's metabolic state (e.g., the general condition of a subject's metabolic system, including its functionality) via one or more chemical indicators that may be detected in a subject's breath. Metabolic rates may, for example, be evaluated globally, such that all types of energy consumed are included in an evaluation. For example, overall metabolic rate may be linked to the presence and/or levels of acetone and/or carbon dioxide in a subject's breath. Detection of acetone and/or carbon dioxide and/or quantification of levels of one or more of these species from a subject's breath may be used to assess a subject's metabolic rate. In other instances, an evaluation of metabolic rate may include a subset of energy sources that are metabolized, such, as for example, one or more macronutrients (e.g., lipids, proteins, carbohydrates). Acetone and other ketone bodies, for example, may be detected to indicate the burn rate of one or more macronutrients. The rapid assessment of a subject's overall metabolic rate and/or metabolic rate of a subset of one or more macronutrient energy sources may be useful in personal fitness monitoring as a subject's metabolic rates may be used to assess the subject's level of physical fitness in, or nearly in, real-time.

Devices and/or methods for chemical sensing may be useful in screening for alcohol intoxication. Alcohol intoxication may include the temporary impaired physiologic state induced by the consumption of alcohol (e.g., ethanol). In such a case, alcohol may accumulate in the bloodstream of a subject due to saturated liver metabolism of the alcohol. Monitoring of alcohol levels, for example, may be critical in determining whether a subject is too impaired to safely operate machinery, such as, for example, an automobile. Blood alcohol content (BAC) may be obtained indirectly by detecting levels of alcohol in a subject's breath. Correlations between breath alcohol content and BAC are available and may be included in screening for alcohol intoxication.

Devices and/or methods for chemical sensing may be useful in screening for halitosis. Halitosis, often referred to as “bad breath”, may be transient or may be chronic and is generally the result of one or more underlying physiologic and/or pathologic causes. In some examples, halitosis may be caused by bacteria that may thrive on a subject's tongue or other region of a subject's mouth. Bacteria, for example, may yield a number of poignant species that may be detected with non-limiting examples that include indole, skatole, polyamines, hydrogen sulfide, methyl mercaptan, allyl methyl sulfide, dimethyl sulfide, and combinations thereof. In other examples, halitosis may be caused by calcified matter in tonsillar crypts that, when released into a subject's breath, may produce a foul order. Such calcified material may be detected in a subject's breath. In still other examples, halitosis may be caused by nitrosothiols in a subject's breath and may be detected.

Devices and/or methods for chemical sensing may be useful in assessing air quality. Higher quality air generally comprises relatively lower levels of additional materials when compared to lower quality air that comprises relatively higher levels of such materials. It may be desirable to assess air quality in a number of contexts, with non-limiting examples that include the levels of atmospheric air pollution and the presence of volatile hazardous or biohazardous materials in atmospheric air. Levels of atmospheric pollution with respect to one or more chemicals, for example, may be monitored by regulatory agencies and/or industrial organizations in order to ensure public and/or environmental safety. Moreover, the monitoring of hazardous and biohazardous materials in atmospheric air may be desired, for example, in the case of an accidental chemical spill or unsuspected release of a hazardous material, such as a poison gas. For example, ammonia may be harmful to occupants of an outer space habitat (e.g., a space station), which generally comprise very closed environments. Ammonia is integral to life on a space habitat because it dissipates heat originating from the inside of the station by traveling through pipes and outside to space. Ammonia, however, is volatile and poisonous when inhaled. Therefore, any leak must be detected quickly and dealt with accordingly. The human nose may be capable of detecting ammonia down to about 50 parts per million, while hazardous levels are in the fewer than 10 parts per million range. Thus, it is quite possible that occupants of may be in danger without even knowing it. As such, rapid, regular detection of ammonia at levels where the human nose is insensitive could be useful in preventing astronaut poisoning.

Devices and/or methods for chemical sensing may be useful in preventing terrorism and/or minimizing the impacts of terrorism. Terrorist attacks may often be executed in public places (e.g., modes of transportation, crowded areas, etc.) using devices that contain volatile compounds that include hazardous biological, chemical, and/or explosive agents. While it may be true that a particular venue that handles large amounts of people do have first-line defenses protecting against such attacks, many screening modalities (e.g., sniffing dogs, X-ray machines, etc.) may be limited in their capabilities to properly detect a threat. In the status quo, the most comprehensive mode of detection of a chemical or biological agent used for terrorism would be a comprehensive laboratory study of a relevant sample. Unfortunately, however, acts of terrorism are unannounced and may happen far too quickly for samples to be taken, properly prepared, and analyzed. Moreover, laboratory studies may also require large equipment that is far too impractical to be used in the many types of locations where terrorism occurs. In this case, compact devices and methods capable of fast, rapid detection, may be more practical and may reduce the time needed to detect potential threats and/or minimize casualties after an attack.

### Computer Systems for Analyte Detection and Identification

Another aspect of the disclosure provides a system that is programmed or otherwise configured to implement the methods of the disclosure, such as analyte detection. The system can include a computer system that is operatively coupled to a sensing device. As an alternative, the computer system can be part of the sensing device.

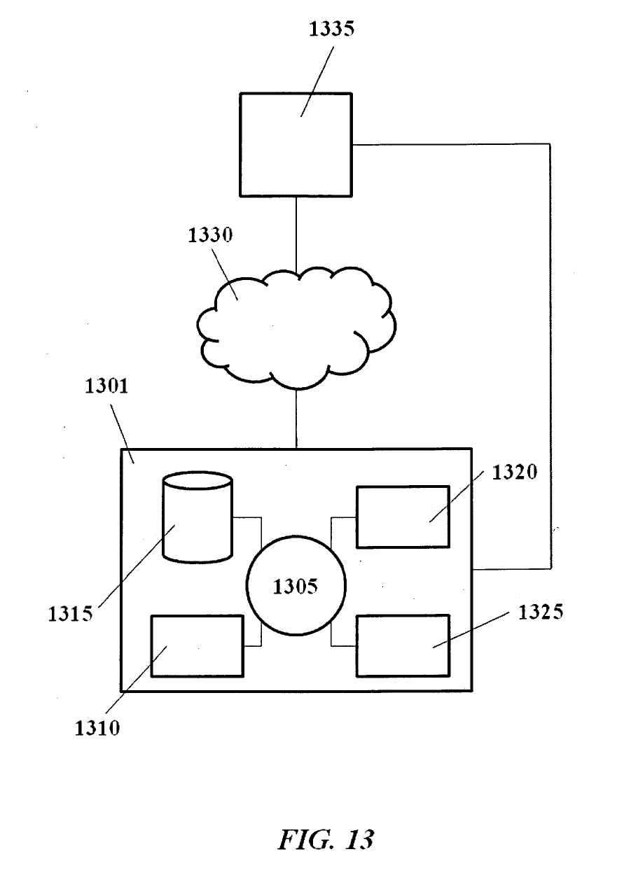

FIG. 13 shows a computer system 1301 that is programmed to implement methods described herein. The computer system 1301 can be part of a sensing device, as describe above and elsewhere herein, or a standalone computer system that is operatively coupled to a sensing device.

The computer system 1301 includes a central processing unit (CPU, also “processor” and “computer processor” herein) 1305, which can be a single core or multi core processor, or a plurality of processors for parallel processing. The computer system 1301 also includes memory 1310 (e.g., random-access memory, read-only memory, flash memory), electronic storage unit 1315 (e.g., hard disk), communications interface 1320 (e.g., network adapter) for communicating with one or more other systems, and peripheral devices 1325, such as cache, other memory, data storage and/or electronic display adapters. The memory 1310, storage unit 1315, interface 1320 and peripheral devices 1325 are in communication with the CPU 1305 through a communications bus (solid lines), such as a motherboard. The storage unit 1315 can be a data storage unit (or data repository) for storing data. The computer system 1301 is operatively coupled to a computer network (“network”) 1330 with the aid of the communications interface 1320. The network 1330 can be the Internet, an internet and/or extranet, or an intranet and/or extranet that is in communication with the Internet. The network 1330 in some cases is a telecommunication and/or data network. The network 1330 can include one or more computer servers, which can enable distributed computing, such as cloud computing. The network 1330 in some cases, with the aid of the computer system 1301, can implement a peer-to-peer network, which may enable devices coupled to the computer system 1301 to behave as a client or a server.

The storage unit 1315 can store information related to analyte detection and identification, such as, for example, sensor data that corresponds to the identity of a given analyte, and chemical fingerprint information. The storage unit 1315 can store user data, such as, e.g., user preferences and a user transaction history. The computer system 1301 in some cases can include one or more additional data storage units that are external to the computer system 1301, such as located on a remote server that is in communication with the computer system 1301 through an intranet or the Internet.

The computer system 1301 can be operatively coupled to a sensing device (or sensor) 1335, either directly (e.g., wired connection, wireless connection) or through the network 1330. In the illustrated example, the computer system 1301 is in communication with the sensing device 1335 through either a direct connection to the sensing device 1335, or through the network 1330. The computer system 1301 can store chemical fingerprint information, which can aid in identifying one or more analytes from a sample detected by the sensing device 1335.

The computer system 1301 can be, for example, a personal computer (e.g., portable PC), slate or tablet PC (e.g., Apple® iPad, Samsung® Galaxy Tab), telephone, Smart phone (e.g., Apple® iPhone, Android-enabled device, Blackberry®), or personal digital assistant. As an alternative, the computer system 1301 can be a sensing device that includes the various illustrated components.

In an example, the computer system 1301 is a standalone computer system that is coupled to the sensing device 1335, which can be located in proximity to or remotely with respect to the computer system 1301. A user can use the sensing device 1335 to detect one or more analytes, and transmit data to computer system 1301 for data analysis, including analyte identification. As an alternative, the computer system 1301 and the sensing device 1335 can be an integrated unit. Thus, various components of the computer system 1301 may be part of the sensing device 1335.

In some situations the computer system 1301 is a single computer system. As an alternative, the computer system 1301 includes multiple computers (e.g., servers) in communication with one another through an intranet and/or the Internet.

The computer system 1301 can be adapted to store user profile information, such as, for example, a name, physical address, email address, telephone number, instant messaging (IM) handle, educational information, and work information of a user. Such profile information can be stored on the storage unit 1315 of the computer system 1301.

Methods as described herein can be implemented by way of machine (or computer processor) executable code (or software) stored on an electronic storage location of the computer system 1301, such as, for example, on the memory 1310 or electronic storage unit 1315. During use, the code can be executed by the processor 1305. In some examples, the code can be retrieved from the storage unit 1315 and stored on the memory 1310 for ready access by the processor 1305. In some situations, the electronic storage unit 1315 can be precluded, and machine-executable instructions are stored on memory 1310.

The code can be pre-compiled and configured for use with a machine have a processer adapted to execute the code, or can be compiled during runtime. The code can be supplied in a programming language that can be selected to enable the code to execute in a pre-compiled or as-compiled fashion.

Aspects of the systems and methods provided herein, such as the computer system 1301, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The server 1301 can be configured for data mining, extract, transform and load (ETL), or spidering (including Web Spidering where the system retrieves data from remote systems over a network and access an Application Programmer Interface or parses the resulting markup) operations, which may permit the system to load information from a raw data source (or mined data) into a data warehouse. The data warehouse may be configured for use with a business intelligence system (e.g., Microstrategy®, Business Objects®). The system can include a data mining module adapted to search for media content in various source locations, such as email accounts and various network sources, such as social networking accounts (e.g., Facebook®, Foursquare®, Google+®, Linkedin®) or on publisher sites, such as, for example, weblogs.

Information can be presented to a user on a user interface (UI), such as a graphical user interface (GUI), of an electronic device of the user. A GUI can enable a user to access the results of a test performed on a given sample (e.g., breath sample, gas sample), such as to identify one or more analytes in the sample. The UI, such as GUI, can be provided on a display of an electronic device of the user. The display can be a capacitive or resistive touch display, or a head-mountable display (e.g., Google® Glasses). Such displays can be used with other systems and methods of the disclosure.

Methods of the disclosure can be facilitated with the aid of applications (apps) that can be installed on electronic devices of a user. An app can include a GUI on a display of the electronic device of the user. The app can be programmed or otherwise configured to facilitate various functions of the sensing device 1335, such as, for example, analyte detection and identification. Such functions may be implemented by the computer system 1301.

Sensing systems of the present disclosure can be standalone systems or integrated with other systems or devices. For example, a sensing system can be a standalone system that is configured to detect one or more analytes in a fluid. As another example, a sensing system can be part of or attached to a mobile electronic device.

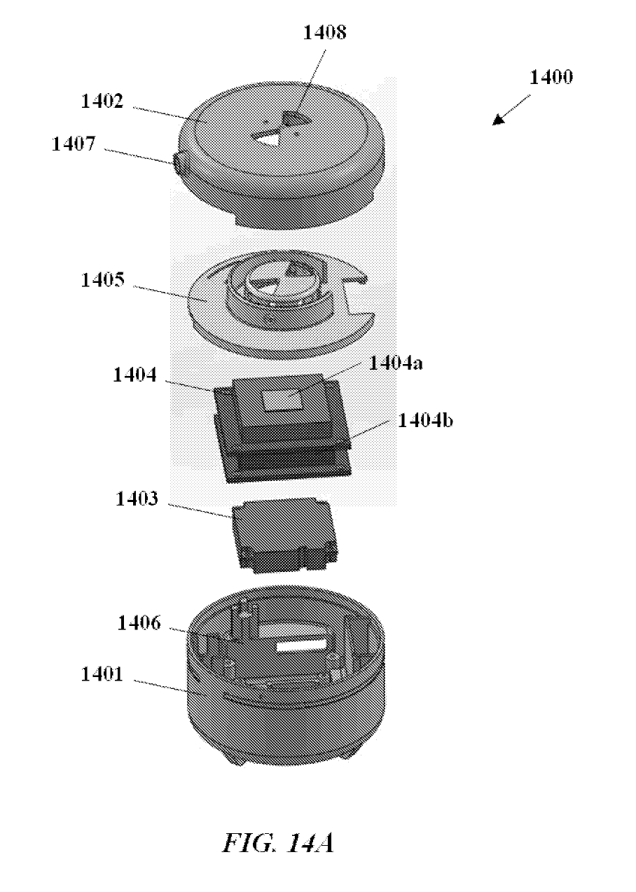

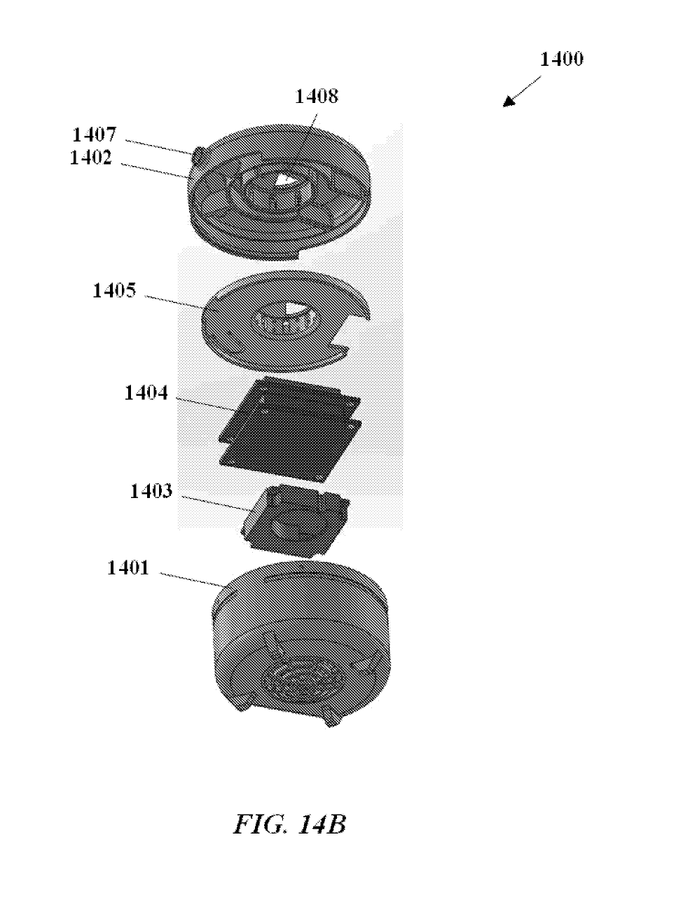

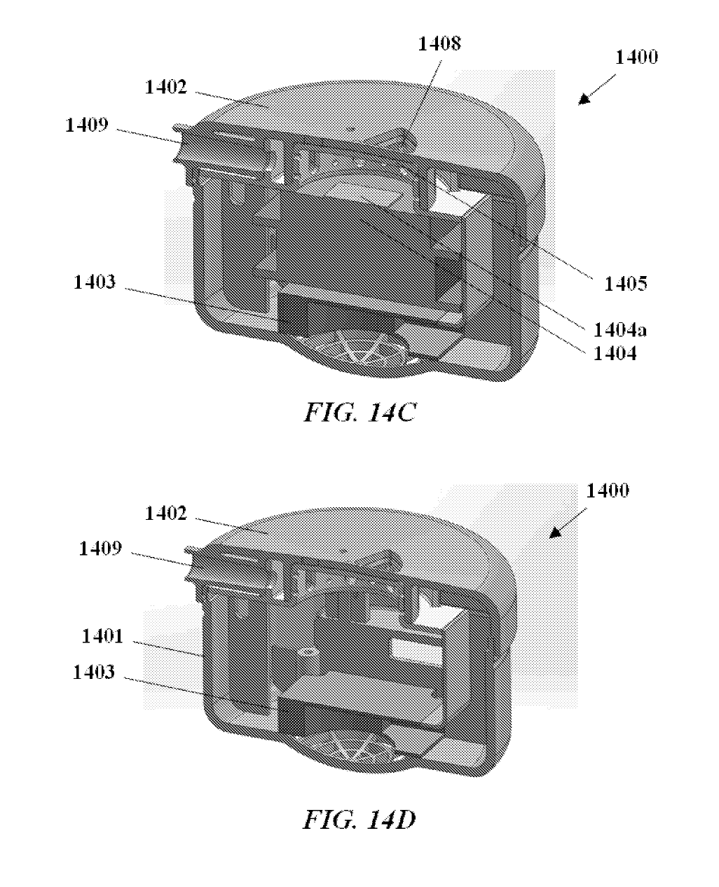

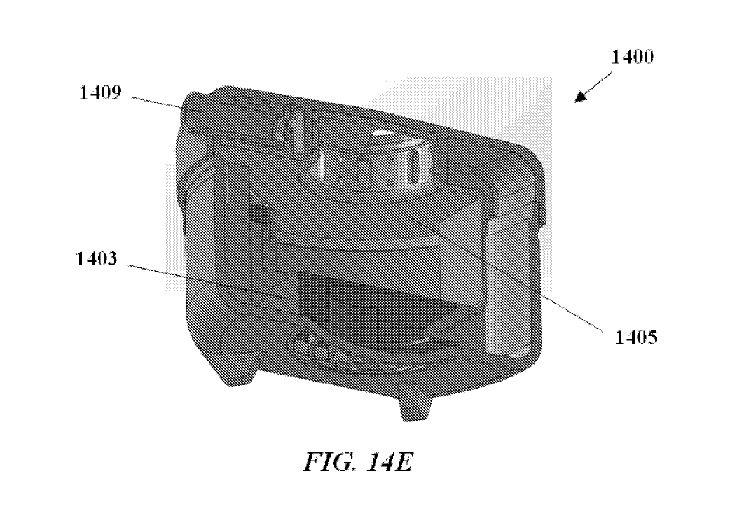

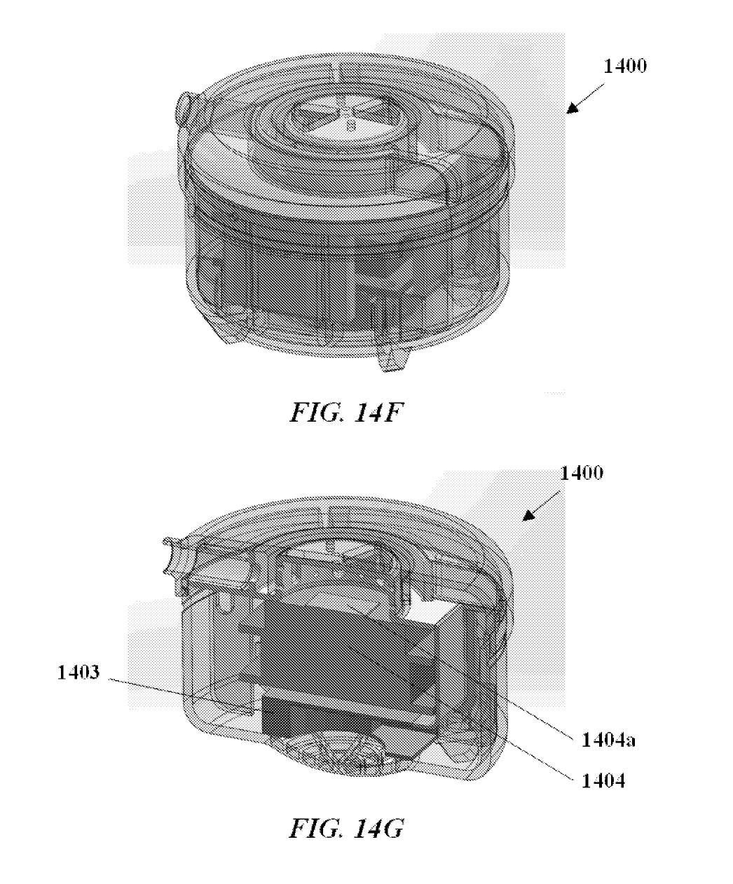

FIGS. 14A and 14B are schematic exploded top and bottom views, respectively, of a sensing system 1400. The system 1400 comprises a housing 1401 and cover 1402. The system 1400 further comprises a fluid flow member 1403, electronic sensor 1404 and fluid flow manifold 1405. A chamber 1406 of the housing 1401 is for holding the fluid flow member 1403 and electronic sensor 1404. The electronic sensor 1404 comprises an array of sensors 1404a, as described above or elsewhere herein. The electronic sensor 1404 can include a computer processor or other logic 1404b. The cover 1402 includes an inlet 1407 and two outlets 1408. The cover 1402 is rotatable relative to the manifold 1405 for aligning the openings of the cover 1402 with the openings of the manifold 1405, which enables or prevents fluid flow through the outlets 1408—e.g., when the openings are aligned, fluid can flow through the outlets 1408, and when the openings are not aligned, fluid does not flow through the outlets 1408. When the openings are closed, the system 1400 may be purged prior to sensing, such as by directing a fluid (e.g., air) from the opening 1407 through the fluid flow member 1403 and out through the bottom of the system 1400.

The fluid flow member 1403 can be a pump or fan for directing fluid flow through the fluid flow manifold 1405. In an example, the fluid flow member 1403 is a fan that is positioned to direct fluid flow from the fluid flow manifold 1405 across the electronic sensor 1404 out of the housing 1401.

With reference to FIGS. 14C, 14D and 14E, the cover 1402 and the fluid flow manifold 1405 provide a fluid flow path (e.g., channel) 1409 for directing a fluid (e.g., vapor) from an environment external to the system 1400 to the array of sensors 1404a of the electronic sensor 1404. In FIG. 14D, the electronic sensor 1404 is not shown. During use, fluid that may comprise one or more analytes is directed along the path 1409 to the electronic sensor 1404 and out of the outlets 1408. FIGS. 14D and 14E show transparent perspective side view of the system 1400.

The system 1400 can include a switch that turns the system on or off. In some examples, the switch is integrated with the 1401. The rotation of the cover 1402 with respect to the housing 1401 can trigger the switch to turn the system 1400, including the fluid flow member 1403 and the electronic sensor 1404, on or off. When the system 1400 is on, the system can be used to detect one or more analytes in a fluid directed to the electronic sensor 1404 along the path 1409.

The system 1400 can include a communications interface (not shown) for coupling the electronic sensor 1404 to an external computer system, which can be used to control the electronic sensor 1404 and/or provide an output of the electronic sensor 1404. The communications interface can be configured for wired or wireless (e.g., WiFi or Bluetooth) connectivity to the computer system or electronic display.

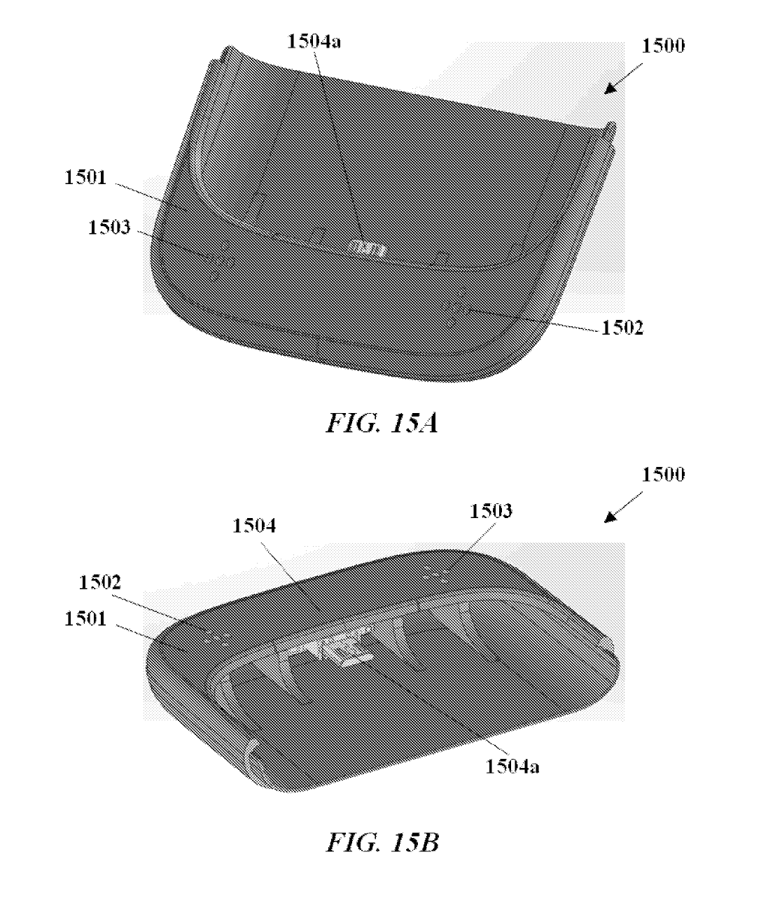

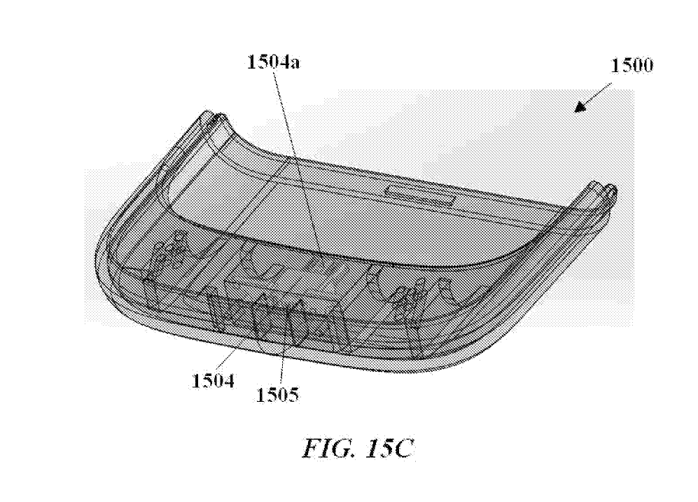

FIGS. 15A-15C schematically illustrate various views of a sensing system 1500 comprising a housing 1501, a first set of openings 1502 and a second set of openings 1503. The sensor 1500 includes an electronic sensor 1504 with a communications interface 1504a for providing wired connectivity to a computer system, such as a mobile electronic device (e.g., Smart phone or tablet PC). The communications interface 1504a can be a male connector that is configured to couple to a female connector of the computer system. In an example, the housing 1501 couples to a bottom portion of a Smart phone or tablet PC. The electronic sensor can include an array of individual sensors, as described above or elsewhere herein. For example, the electronic sensor 1504 can include individual sensors that each includes an FET comprising one or more nanostructures (e.g., nanotubes) that can be functionalized for sensing. The electronic sensor 1504 can include a plurality of inlets 1505 that enable a fluid (e.g., vapor) to be directed into the electronic sensor 1504 and brought in contact with individual sensors of the sensor 1504. The system 1500 can further include a fluid flow member (e.g., pump or fan) for directing fluid flow from an environment external to the housing 1501 to the electronic sensor 1504. In an example, during use, fluid (e.g., a vapor) flows from the first set of openings 1502 to the electronic sensor 1504, and from the electronic sensor 1504 to the second set of openings 1503 and out of the system 1500. As an alternative, the direction of fluid flow may be reversed such that fluid flows from the second set of openings 1503 to the electronic sensor 1504, and subsequently to the first set of openings 1502. As another example, during use, fluid flows from the first and second openings 1502 and 1503, respectively, to the electronic sensor 1504.

The system 1500 can include a computer processor or other logic (e.g., ASIC). As another example, the system 1500 does not include a computer processor. In such a case, an external computer processor can be used to control the system 1500. For example, a computer processor of a mobile electronic device can be used to control the system 1500 when the housing 1501 is coupled to the mobile electronic device.

### EXAMPLES

### Example 1

A set of six laboratory experiments are conducted such that three different SWNT-FET sensors are each contacted with an air mixture comprising methylphosphonate (DMMP) and, separately, an air mixture comprising methanol. DMMP is a simulant for Sarin gas, which is a poison gas that may be used to execute a terrorist attack. The experiments are conducted such that the air mixture is at 3% saturation with respect to its DMMP or methanol component and such that air comprising DMMP or methanol and pure air are alternately contacted with a respect to a SWNT-FET sensor over time. The SWNT sensing element of each SWNT-FET sensor is functionalized with a 24-mer ssDNA binding agent, wherein the ssDNA binding agent for each SWNT-FET is isomeric of the ssDNA binding agents of the other two SWNT-FET sensors. Each SWNT-FET sensor is distinguished by the sequence of its associated ssDNA indicated by Seq. 2, Seq. 2α, and Seq. 2β.

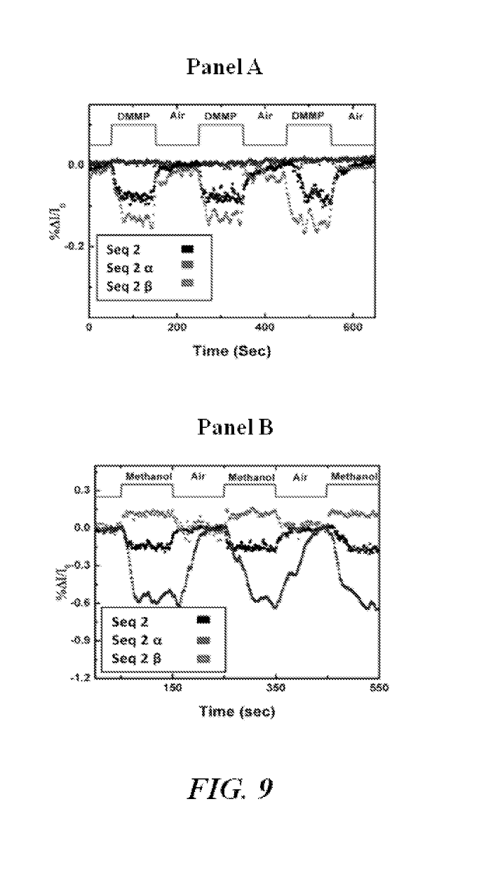

Responses (manifested as a percent change in initial current recorded from the SWNT-FET sensor) from a SWNT-FET sensor are recorded with respect to time and displayed in FIG. 9. Results for DMMP experiments are shown in panel A and results for methanol experiments are shown in panel B. As shown in FIG. 9, none of the Seq. 2, Seq. 2α, or Seq. 2β SWNT-FET sensors generally displays a response when contacted with pure air. However, upon contact with air comprising DMMP, Seq. 2α SWNT-FET sensor and Seq. 2 SWNT-FET sensor both display negative responses, wherein the response of Seq. 2α SWNT-FET sensor is greater in magnitude. Seq. 2β SWNT-FET sensor, on the other hand, shows little to no response in the presence of air comprising DMMP.

Varied results between sensor types are also recorded for methanol experiments. Upon contact with air comprising methanol, Seq. 2β SWNT-FET sensor and Seq. 2 SWNT-FET sensor both display negative responses, wherein the response of Seq. 2β SWNT-FET sensor is greater in magnitude. Moreover, Seq. 2α SWNT-FET sensor displays a positive response, of similar magnitude (but opposite sign) of Seq. 2 SWNT-FET sensor. Data in FIG. 9 indicate that isomeric ssDNA binding agents may behave differently from when in contact with a given analyte, and, thus, such differences in behavior may modulate the response an associated sensor displays. Moreover, the different response behaviors observed between isomeric ssDNA SWNT-FETs suggest that a large diversity of sensors may be assembled with mere alteration of component base sequencing.

### Example 2

Two sets of laboratory experiments are conducted using an SWNT-FET sensor comprising a SWNT sensing element that is functionalized with a single 24-mer ssDNA (sequence: 5′ GAG TCT GTG GAG GAG GTA GTC 3′) binding agent. In the first set, the SWNT-FET sensor is separately contacted with air samples each comprising one of the following organic acids: octanoic acid, hexanoic acid, or propanoic acid. Air samples vary in their respective component concentration, represented by a percent saturated vapor. In the second set, the SWNT-FET sensor is separately contacted with air samples comprising one of the following aldehydes: octanal, nonanal, or decanal. Air samples vary in their respective component concentration, represented by a percent saturated vapor. The chemical species in both sets of experiments are structurally similar and differ by only a few methylene (e.g., —CH₂) groups. In the second set, octanal, nonanal, and decanal sequentially differ by only a single methylene group.

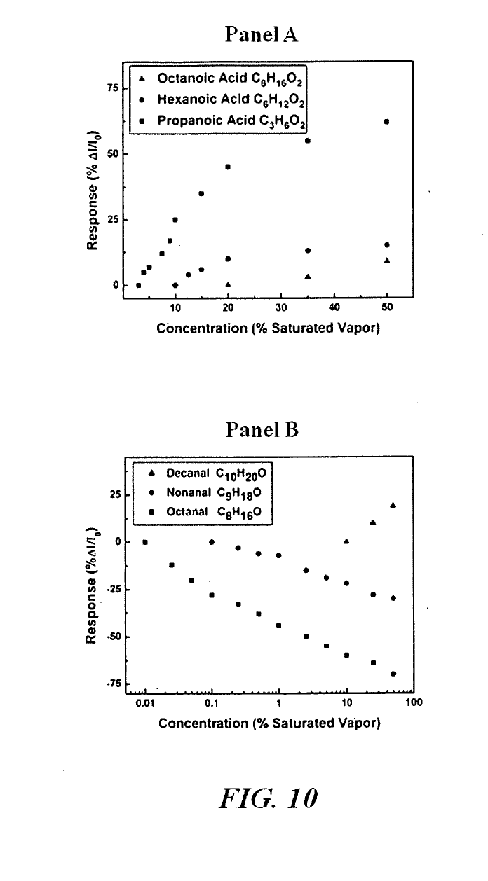

Responses (manifested as a percent change in initial current recorded from the SWNT-FET sensor) from the SWNT-FET sensor are recorded with respect to component concentration in FIG. 10. Results for the organic acid experiments are shown in panel A and results for the aldehyde experiments are shown in panel B. As shown in FIG. 10 panel A, the SWNT-FET sensor responds in a similar pattern to each of the organic acids tested—response is positive and generally increases in magnitude with increasing concentration. The magnitudes recorded, however, depend on the chemical species analyzed. For example, relatively lower magnitudes are observed for propanoic acid when compared to hexanoic or octanoic acid. Such differences in magnitude appear to permit some level of discrimination between the three organic acids.

Results observed for aldehyde experiments are varied. As shown in FIG. 10 panel B, the SWNT-FET sensor responds in a similar pattern to nonanal and octanal—response is negative and generally increases in magnitude with increasing concentration. The magnitudes recorded, however, depend on the chemical species analyzed. Relatively lower magnitudes are observed for nonanal when compared to octanal. Conversely, the SWNT-FET sensor responds in opposite fashion to decanal—responses are generally positive and generally increase in magnitude with increasing concentration. The combination of differences observed in response magnitude and sign of appears to permit some level of discrimination between the three aldehydes tested. Data in FIG. 10 indicate that ssDNA SWNT-FET sensors may be capable of discriminating structurally similar chemical species, including those that differ by only a single atom or group. Moreover, data indicate that sensing via an ssDNA SWNT-FET may be quantitative as indicated by the trending responses recorded with varied concentration shown in both panels A and B of FIG. 10.

### Example 3

A set of laboratory experiments is conducted using an SWNT-FET sensor comprising a sensing element that is modified with a single 24-mer ssDNA (sequence: 5′ GAG TCT GTG GAG GAG GTA GTC 3′) binding agent. The SWNT-FET sensor is separately contacted with air samples each comprising one of the following isomeric species: n-hexanoic acid, 2-methyl pentanoic acid, or 4-methyl pentanoic acid. n-hexanoic acid is a linear, straight-chain organic acid, whereas 2-methyl pentanoic acid and 4-methyl pentanoic acid are branched isomers of n-hexanoic acid that differ in the carbon atom at which branching occurs. Air samples vary in their respective component concentration, represented by a percent saturated vapor.

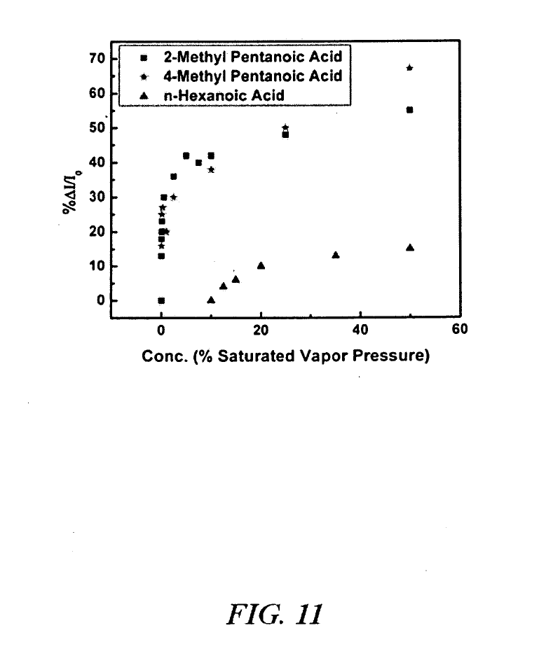

Responses (manifested as a percent change in initial current recorded from the SWNT-FET sensor) from the SWNT-FET sensor are recorded with respect to component concentration in FIG. 11. As shown in FIG. 11, the SWNT-FET sensor responds in a similar pattern to each of isomers tested—response is positive and generally increases in magnitude with increasing concentration, appearing to reach an asymptotic value at high concentrations. The magnitudes recorded, however, depend on the chemical species analyzed. For example, relatively lower magnitudes are observed for n-hexanoic acid when compared to 2-methyl pentanoic acid or 4-methyl pentanoic acid. Magnitudes, though, are similar between both branched isomers. Where it may be difficult to discriminate 2-methyl pentanoic acid from 4-methyl pentanoic acid using the SWNT-FET sensor, the magnitude difference observed for n-hexanoic acid relative its branched isomers may be used in its discrimination for the branched species. As a result, data in FIG. 11 indicate that ssDNA SWNT-FET sensors may be capable of discriminating similar chemical species, including those that are structurally-different isomers. Moreover, data indicate that sensing via an ssDNA SWNT-FET may be quantitative as indicated by the trending responses recorded with varied concentration shown FIG. 11.

### Example 4

Two sets of laboratory experiments are conducted using an SWNT-FET sensor comprising a sensing element that is modified with a single 24-mer ssDNA (sequence: 5′ GAG TCT GTG GAG GAG GTA GTC 3′) binding agent. In the first set, the SWNT-FET sensor is separately contacted with air samples each comprising one of the following enantiomers: (+)-limonene and (−)-limonene. Air samples vary in their respective component concentration, represented by a percent saturated vapor. In the second set, the SWNT-FET sensor is separately contacted with air samples comprising one of the following enantiomers: L-carvone and D-carvone. Air samples vary in their respective component concentration, represented by a percent saturated vapor. The chemical species in both sets of experiments are structurally identical and vary only in their three-dimensional configurations, such that the structure of one molecule in a set is a mirror image of its corresponding pair.

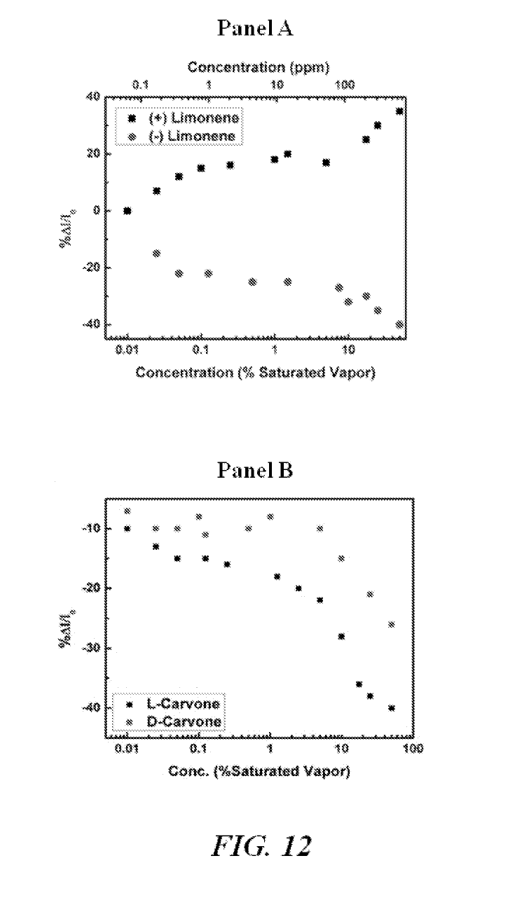

Responses (manifested as a percent change in initial current recorded from the SWNT-FET sensor) from the SWNT-FET sensor are recorded with respect to component concentration in FIG. 12. Results for the limonene experiments are shown in panel A and results for the carvone experiments are shown in panel B. As shown in FIG. 12 panel A, the SWNT-FET sensor responds in different patterns to the two limonene enantiomers tested. The response for (+)-limonene is generally positive and generally increases in magnitude with increasing concentration. With respect to (−)-limonene, however, response is generally negative and generally increases in magnitude with increasing concentration. Such differences in sign of response appear to permit some level of discrimination between the structurally identical limonene enantiomers.

Different results are observed for the carvone experiments. As shown in FIG. 12 panel B, the SWNT-FET sensor responds in a similar pattern to both enantiomers—response is negative and generally increases in magnitude with increasing concentration. The magnitudes recorded, however, depend on the enantiomer analyzed. Relatively lower magnitudes are observed for D-carvone when compared to L-carvone. In this case, the difference observed in response magnitude appears to permit some level of discrimination between the enantiomers tested. Data in FIG. 12 indicate that ssDNA SWNT-FET sensors may be capable of discriminating structurally identical chemical species, such as stereoisomers or enantiomers. Moreover, data indicate that sensing via an ssDNA SWNT-FET may be quantitative as indicated by the trending responses recorded with varied concentration shown in FIG. 12.

Devices, systems and methods of the present disclosure can be combined with or modified by other devices, systems and methods, such as those described in PCT/US2010/033968, PCT/US2006/012005, PCT/US2007/015999, U.S. patent application Ser. No. 13/318,682, U.S. patent application Ser. No. 11/910,070, U.S. patent application Ser. No. 12/373,654, and U.S. Pat. No. 7,977,054, each of which is entirely incorporated herein by reference.

It should be understood from the foregoing that, while particular implementations have been illustrated and described, various modifications can be made thereto and are contemplated herein. It is also not intended that the invention be limited by the specific examples provided within the specification. While the invention has been described with reference to the aforementioned specification, the descriptions and illustrations of the preferable embodiments herein are not meant to be construed in a limiting sense. Furthermore, it shall be understood that all aspects of the invention are not limited to the specific depictions, configurations or relative proportions set forth herein which depend upon a variety of conditions and variables. Various modifications in form and detail of the embodiments of the invention will be apparent to a person skilled in the art. It is therefore contemplated that the invention shall also cover any such modifications, variations and equivalents. It is intended that the following claims define the scope of the invention and that methods and structures within the scope of these claims and their equivalents be covered thereby.

1. An analyte sensing system, comprising:
(a) an array of individually addressable sensors, wherein each individually addressable sensor of said array comprises a field effect transistor (FET) comprising a source and a drain and at least one nanostructure electrically coupling said source to said drain, which FET has a difference between a maximum current (Iₒₙ) and a minimum current (I_{off}) from about 30 nanoamps (nA) and 15000 nA at a source-drain voltage (V_{sd}) of about 100 mV;
(b) a vapor distribution member comprising a fluid flow path in fluid communication with said array, wherein said vapor distribution member is configured to bring a fluid comprising one or more analytes in contact with said array; and
(c) a computer processor in communication with said array of individually addressable sensors, wherein said computer processor is programmed to (i) receive electrical signals generated by said array upon contacting said array with said fluid comprising one or more analytes, and (ii) identify a given analyte of said one or more analytes.

2. The system of claim 1, wherein said Iₒₙ-I_{off} is from about 500 nA to 3000 nA at a V_{sd} of about 100 mV.

3. The system of claim 1, wherein said at least one nanostructure is functionalized with a nucleic acid.

4.-6. (canceled)

7. The system of claim 1, wherein said at least one nanostructure is a nanotube.

8. The system of claim 1, wherein said at least one nanostructure comprises a first nanostructure and a second nanostructure, wherein said first nanostructure is in contact with one of said source and said drain, but not both, and wherein said second nanostructure is in contact with said first nanostructure.

9. (canceled)

10. The system of claim 1, further comprising a mobile electronic device comprising said computer processor.

11. A method for analyte detection, comprising:
(a) providing a sensing system, comprising:
(i) an array of individually addressable sensors, wherein each individually addressable sensor of said array comprises a field effect transistor (FET) comprising a source and a drain and at least one nanostructure electrically coupling said source to said drain, which FET has a difference between a maximum current (Iₒₙ) and a minimum current (I_{off}) from about 30 nanoamps (nA) and 15000 nA at a source-drain voltage (V_{sd}) of about 100 mV;
(ii) a vapor distribution member comprising a fluid flow path in fluid communication with said array, wherein said vapor distribution member is configured to bring a fluid comprising one or more analytes in contact with said array; and
(iii) a computer processor coupled to said array of individually addressable sensors, wherein said computer processor is programmed to (i) receive electrical signals generated by said array upon contacting said array with said fluid comprising one or more analytes, and (ii) identify a given analyte of said one or more analytes; and
(b) using the vapor distribution manifold, bringing a fluid in contact with said array; and
(c) using said computer processor, detecting the presence or absence of one or more analytes in said fluid.

12.-24. (canceled)

25. A chemical vapor sensing device comprising
a) a support;
b) an array of individual sensors on said support, wherein an individual sensor of said array is capable of generating a response upon exposure to an analyte in a sample,
wherein said individual sensor is a single wall nanotube field-effect transistor (SWNT-FET) comprising a single-stranded DNA (ssDNA) functionalized single-walled carbon nanotube (SWNT) sensing element, and
wherein said array occupies a total area of no more than 100 mm².

26.-28. (canceled)

29. The device of claim 25, wherein said array has a volume of no more than 0.2 mm³.

30.-32. (canceled)

33. The device of claim 25, wherein said individual sensors comprise sensing elements that are carbon nanotubes (CNTs).

34. The device of claim 33, wherein said sensing elements are functionalized with one or more binding agents.

35. The device of claim 34, wherein said one or more binding agents are selected from the group consisting of a biopolymer, Naffion, polyimide, nanoporous silica, porphyrins, metallo-porphyrins, polyethyleneimide, conductive polymers, metallic nanoparticles, buckminsterfullerene, graphene flakes, graphene oxide flakes, reduced graphene oxide flakes, and combinations thereof.

36. (canceled)

37. The device of claim 34, wherein said one or more binding agents is a polynucleotide.

38.-41. (canceled)

42. The device of claim 33, wherein the diameter of said CNTs is in the range of 0.5 nm-5 nm.

43. (canceled)

44. (canceled)

45. The device of claim 33, wherein said CNTs are single-walled carbon nanotubes (SWNTs).

46.-50. (canceled)

51. The device of claim 25, wherein said array comprises at least about 1024 said individual sensors.

52. (canceled)

53. The device of claim 25, wherein said array has a sensor density of at least about sixteen said individual sensors/mm².

54. (canceled)

55. The device of claim 25, wherein said at least one array comprises at least five different types of individual sensors.

56. (canceled)

57. (canceled)

58. The device of claim 25, further comprising a control assembly that is configured to communicate with said array.

59. The device of claim 58, wherein said control assembly comprises a processor that is in communication with said array.

60.-102. (canceled)
